(19) United States
(12) Patent Application Publication
(10) Pub. No.: US 2013/0139125 A1
(43) Pub. Date: May 30, 2013

(54) METHOD AND SYSTEM FOR DATA MODELING ACCORDING TO OBJECT PERSPECTIVES

(71) Applicant: Jonathan McCoy, Palo Alto, CA (US)

(72) Inventor: Jonathan McCoy, Palo Alto, CA (US)

(73) Assignee: PERCEPTION LABS, Palo Alto, CA (US)

(21) Appl. No.: 13/481,688

(22) Filed: May 25, 2012

Related U.S. Application Data
(63) Continuation-in-part of application No. 12/098,996, filed on Apr. 7, 2008, now abandoned.
(60) Provisional application No. 60/910,399, filed on Apr. 5, 2007.

(51) Int. Cl. G06F 9/44

(52) U.S. Cl. CPC G06F 8/20
USPC 717/104

(57) ABSTRACT

Techniques for the design and use of a perception modeling language for communicating according to the perspective of at least two communicators. The disclosed method and system provide for forming a model including a predetermined number of states and a plurality of related transitions. The disclosed subject matter represents each of said predetermined number of states according to a plurality of perspectives, said perspectives including a plurality of states and a set of related transitions, and forms a perspective language by deriving a plurality of functions associating said plurality of perspectives for representing at least one actually observable system. Furthermore, the perspective modeling language derives a set of modeling perspectives for modeling said at least one actually observable system.

### RELATED APPLICATIONS

This application is a Continuation-in-part (CIP) of U.S. patent application Ser. No. 12/098,996 entitled “Method And System For Data Modeling According To User Perspectives” filed Apr. 7, 2008 which claims the benefit of priority to U.S. Provisional Patent Application No. 60/910,399 entitled, “Method and System for Language Modeling According to User Perspectives” filed Apr. 5, 2007 by inventor Jonathan McCoy and is incorporated herein in its entirety.

### FIELD

The disclosed subject matter relates to communications technologies and methods of communicating. More particularly, this disclosure relates to a method and system for modeling data according to a perspective oriented-paradigm.

### DESCRIPTION OF THE RELATED ART

Commonly accepted parts of speech in English and many other languages, including nouns, verbs, adjectives, adverbs, and prepositions, allow relating words and phrases together meaningfully and understandably. This formalization of language enables a protocol for communicating. Talking, reading, and writing are all more elegant and efficient as a result of formalized rules governing the use of these parts of speech.

Parts of speech, in combination with the higher level grammar rules derived from parts of speech form a language paradigm—a human language paradigm. However, nouns and verbs are only one way to describe an object and the function of that object. A noun refers to a person, place or thing and is a most fundamental component that people use to describe the world around them. A verb, on the other hand, describes the events or actions of a noun, providing a most fundamental way to relate the action of a noun over time. Individuals communicate seamlessly about many topics using nouns and verbs, but there may be other ways to describe objects, and the actions of those objects.

Nouns form one class of constructs to describe objects, while verbs form a class of constructs to describe actions of objects. Both nouns and verbs commonly assume a common perceptive reality of each communicator. Each communicator must have a common conception and perception of every person, place or thing around them, and their respective actions in order for efficient and effective communication to result. However, often an object or action may not have the same meaning to each communicator. The result becomes a miscommunication or semantic disconnect between the communicators. Thus, human language inherently exhibits serious limitations.

In the generation and use of computer language, still other limitations exist. Object-oriented modeling, for example, provides a basic and introductory action for software development. It should be easy to understand and follow, as well as generic enough in flow to apply to various software programs. The model focuses on logical separation of classes and their integration to one another. It also illustrates behavior, functionality, communication, and data flow. Object-oriented modeling may be abbreviated or in-depth.

To further illustrate, each class in the model forms an object. Each object exhibits different attributes, one action (or purpose), and input and/or output (of messages). Overall, object-oriented modeling shows sequential actions of a software program, as most objects within the model are designated with a task.

From a human language perspective, each object may be classified as a noun and thus each task or action could be classified as their relational verb. In other words, noun/verb modeling possesses parallel structures to object-oriented modeling. Thus, software programmers use object-oriented modeling to both explain a program in general and as a tool to write many small programs, with each part completing a function of the whole entire program. All parts may then link together to form one unified program. Object-oriented modeling allows software developers to reuse segments of software code in many different programs.

Although object-oriented programming provides a tremendously powerful tool for modeling systems in software, the paradigm faces known challenges. For example, while hardware development furthers both local and non-local massive concurrency, local concurrency is being enabled by new hardware for 64-bit multi-core microprocessors, multi-chip modules, and high performance interconnect. New hardware non-local concurrency is being enabled by wired and wireless broadband packet switched communications (e.g., Wi-Fi and Ultra wideband communications). Both local and non-local storage capacities are growing exponentially.

The Actor Model faces issues in computer and communications architecture, concurrent programming languages, and Web Services. These include scalability, including the challenge of scaling concurrency, both locally and non-locally. Transparency also presents a challenge in bridging between local and non-local concurrency. Some researchers, in fact, advocate a strict separation between local concurrency using concurrent programming languages (e.g., Java and C#) from non-local concurrency using SOAP for Web services. Strict separation produces a lack of transparency causing problems when changing between local and non-local Web Services access. Bridging between local and non-local Web Services may even prefer making binary XML or XSD first-class data types in Java and C#. Inconsistency also presents a challenge, because inconsistencies are present in very large knowledge systems involving human information system interactions. These inconsistencies extend also to the documentation and specifications of such large systems (e.g., Microsoft Windows software, etc.), which are themselves internally inconsistent.

In addition, current tools for modeling systems do not provide a way for calculating and reducing information entropy in the communication of the model. Information entropy provides information relating to the efficiency of communication in the system. This limitation mitigates the ability of a modeler to fully understand communications within a system.

Because of these limitations, there is a need for a language providing consistent definition of objects, and which definitions of objects are expressed in terms of other objects using the same definitions.

There is the need for a reflexive architecture that allows an object to be broken down into components using the same method of object definition. In such an architecture, all defined objects in the definition of the object should be translated into components which are universally defined for all observers of a given object.

There is a further need for a language that may be used to define objects in terms of the perspective of any object.

### SUMMARY

The present disclosure includes an improved method and system for modeling data according to object perspectives, and provides a language with consistent definitions of objects, where definitions of objects are expressed as a relation to other objects. The disclosed subject matter includes a reflexive architecture that allows an object to be broken down into components using the same method of object definition. In such an architecture, all defined objects should be translated into components which are universally defined for all observers of a language that may be used to define objects in terms of the perspective of any user. In addition, the present disclosure includes a method for the translation of data found in other databases (such as Microsoft Excel) and languages (such as XML) into a perspective modeling language.

According to one aspect of the disclosed subject matter, a method and system are provided for the design and use of a perspective modeling language for communicating according to the perspective of at least two communicators. The disclosed method and system provide for forming a model including a number of temporally related states and number of temporally related state transitions.

These and other advantages of the disclosed subject matter, as well as additional novel features, will be apparent from the description provided herein. The intent of this summary is not to be a comprehensive description of the claimed subject matter, but rather to provide a short overview of some of the subject matter's functionality. Other systems, methods, features and advantages here provided will become apparent to one with skill in the art upon examination of the following FIGUREs and detailed description. It is intended that all such additional systems, methods, features and advantages be included within this description, be within the scope of the accompanying claims.

### BRIEF DESCRIPTIONS OF THE DRAWINGS

For a more complete understanding of the disclosed subject matter and advantages thereof, reference is now made to the following description taken in conjunction with the accompanying drawings in which like reference numbers indicate like features wherein:

FIG. 1 provides a conceptual illustration of how languages include a structure for communicating about real world environments;

FIG. 2 illustrates problems relating to known language paradigms;

FIGS. 3a, 3b, and 3c disclose different aspects of a perspective;

FIGS. 4 and 5 show aspects of environment relationships of a perspective;

FIG. 6 illustrates exemplary composite relationships of a perspective;

FIGS. 7 and 8 describes aspects of an object relationship of a perspective;

FIG. 9 describes aspects of a perspective and its relationships;

FIG. 10 shows an illustrative example of a channel linking perspectives together;

FIGS. 11a and 11b illustrate aspects of a functional model;

FIGS. 12a, 12b, and 12c describe different facets of a clock for a perspective;

FIGS. 13, 14, and 15 provide input diagrams which may be used in connection with the present disclosure;

FIGS. 16a and 16b show an interaction model and the code that may used to generate an interaction model;

FIGS. 17a and 17b show the code that may be used to generate an interaction graph and an interaction graph;

FIG. 18 provides an exemplary object definition diagram which may be used to relate perspectives through object relationships;

FIGS. 19a and 19b provide an illustrative example of an asynchronous communication channel and the code which may be used to generate an asynchronous communication channel;

FIG. 20 provides a descriptive drawing of an input communication channel;

FIGS. 21a and 21b disclose synchronous communication channels and the code that may be used to generate them;

FIGS. 22a and 22b show code which may be used to generate a network graph and an exemplary network graph;

FIG. 23 illustrates an exemplary communications diagram;

FIGS. 24a through 26b illustrate various composition relationships and the code which may be used to define those relationships;

FIG. 27 provides an exemplary code segment for defining context;

FIGS. 28 through 31 describe various aspects of a Perspective Modeling Language (PML);

FIG. 32 shows an exemplary PML ontology;

FIG. 33 shows steps which may be used to produce a PML;

### DETAILED DESCRIPTION OF THE SPECIFIC EMBODIMENTS

Exemplary embodiments of the disclosed subject matter are illustrated in the FIGURES, like numerals being used to refer to like and corresponding parts of various drawings.

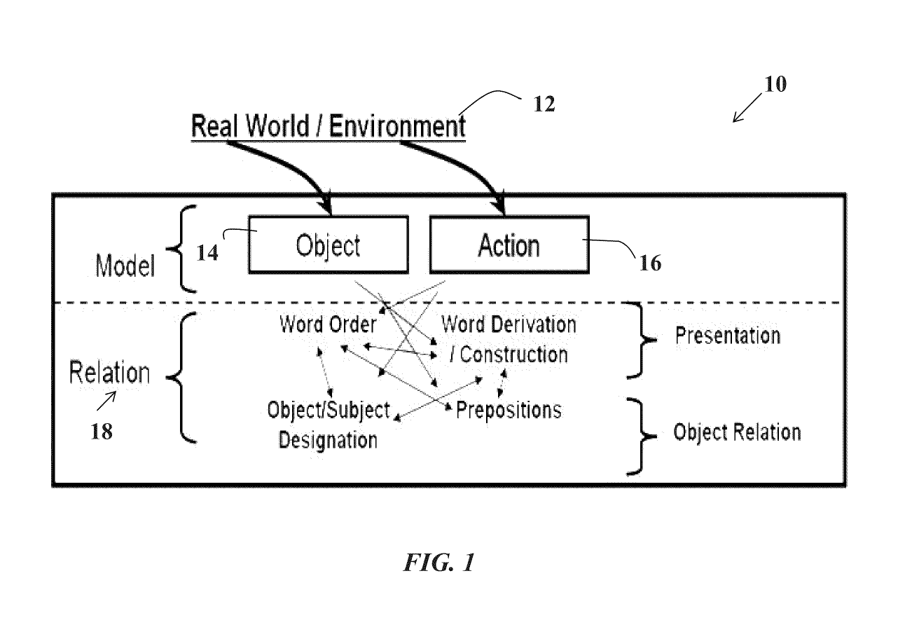

FIG. 1 provides a conceptual illustration of how languages include a structure 10 for communicating about real world environments. Real world/Environment 12 may be modeled according to language protocols having objects 14 and actions 16. This basic structure may be enhanced by components of language model 18 including word order, object/subject designation, prepositions, and word derivation/construction. Using language structure 10, humans can convey information about the real world through language from their perspective.

Human language paradigms seek to model the real world in terms of nouns, verbs, adjectives, and adverbs. The potential to innovate in both software and the web is often viewed as a limitation of available tools. However, the use of language may pose another barrier for the potential to innovate. The ability to Comprehend, Control, Communicate and Simulate the world around us breaks down when things get complicated. Comprehension, Control, Communication and Simulation are all enabled and limited by language. We must communicate with both humans and machines in today's world.

Advances in technology have enabled a whole new level of utility—yet the application of language in process improvement remains relatively unchanged. Current language inhibits designers' ability to model and simulate processes in a meaningful, extensible, and standardized manner. Problem/Symptoms—So, what exactly is the problem with language? Can we use language to ‘teach’ both man and machine without semantic disconnect? No. Can we use the same language in both? Within an organization and within a computer system? No. Can we formulaically build off of existing bodies of knowledge? No. Can we simulate every system for efficiency? No.

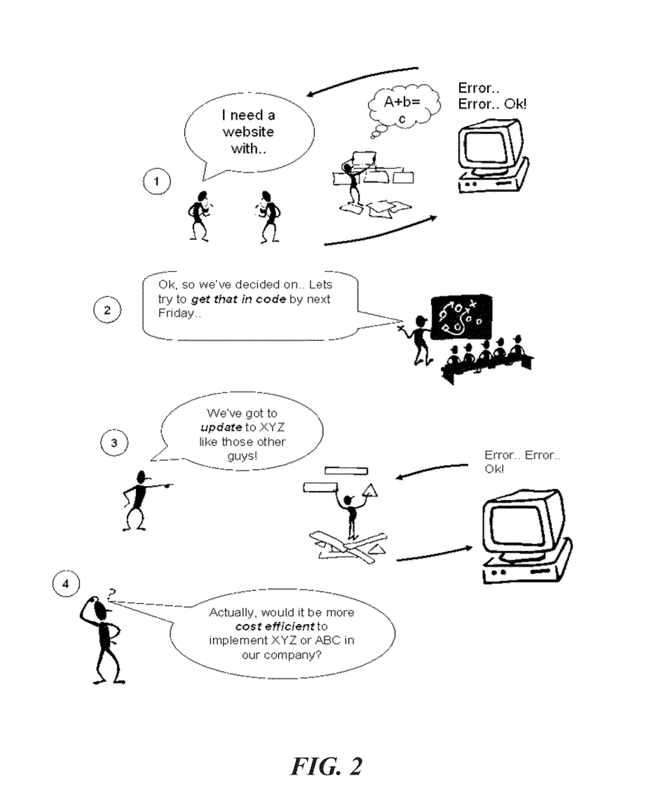

FIG. 2 illustrates problems relating to known language paradigms. The issues facing the Actor Model*—Computer scientists explain the Actor Model in terms of scalability, transparency, and consistency. (They are not concerned about inherent simulation—yet!).

Known problems of current systems include: 1—Scalability—Using the model on local machines as well as remote machines. No Current solution. 2—Transparency—Bridging the chasm between local machine and remote machines. Requires mapping of Internet protocols and languages (XML, SOAP) to machine language (Java, C#). 3—Consistency—large knowledge systems use different terms for objects. Makes communication difficult without->Mapping of terms.

The present disclosure implements a Perspective Modeling Language (PML) to address inherent flaws of previous systems. Current methods and systems do not present consistent methods for addressing ambiguity in the modeling process. PML provides a PML Engine for applying information theory models to objects and their related temporal states. In this way, PML may consistently define the entropy of the model. Further, current methods and systems lack a means for modularly integrating domain knowledge into existing domain-specific languages. For example, the definition of an object may change relative to another new object. By providing objects a perspective, PML enables modular integration of new information to existing models. PML further enables the creation of scalable models. As a modeler gathers new domain-specific knowledge, the data may be seamlessly integrated with existing models. Thus, new data may be successively added to better approximate the state of some observed event.

PML leverages the perspective language paradigm by providing a clear set of goals which empower modelers of software applications. In simulation, PML provides a framework for accurately and efficiently modeling real-world systems and processes. Using PML allows for creating models more readily capable of predicting behavioral functions of a system over time.

The present disclosure provides a modeling language, called the perspective-oriented modeling language based on a perspective-oriented paradigm. PML allows for observing, defining, and communicating about the world contrasting functions that occur using known languages. PML avoids the need to use an object/action paradigm wherein each communicator must share a common perspective and perceive the same thing in the same way. Avoiding this predicament empowers PML users with a protocol for communication. Using a perspective-oriented language paradigm facilitates understanding, analyzing, communicating and simulating complex systems more efficiently, completely, and in a scalable manner.

PML provides a consistent method and system for modeling domain-specific language and knowledge. By creating a domain-specific communications model (i.e. perspective relationships to be described herein), a modeler imparts a consistent method and system to the model. Further, the communications model provides a valuable tool for understanding the rigor and applicability of the model. The PML engine imparts a measure of information entropy to the system allowing a modeler to better understand the quality of the model and additional information which may improve communication within the model.

The perspective-oriented paradigm of PML avoids the use of defining objects in an absolute sense. Objects are created as the result of a defined perspective that observes an object and some state of the objects. The principle of defining an object perspective enables every object to be defined in terms of such perspective, and eliminates the need to assume a perspective, as is an object/action paradigm. Furthermore, in defining dynamic behavior, the perspective-oriented paradigm generally focuses on the time relation of observed object states. As a result, the PML paradigm relegates “action” to only one form of observed time relation. Action is observed by a common, assumed perspective.

To better appreciate the modeling language of the present disclosure, the following paragraphs provide definitions of various terms as used herein.

The term “Perspective” (P) as used herein pertains to an abstract machine, which realizes a formal language, and has a defined relationship with other perspectives. Each perspective has the following properties: “state” (S) and “frequency”. A perspective can have exactly one state at any given time t.

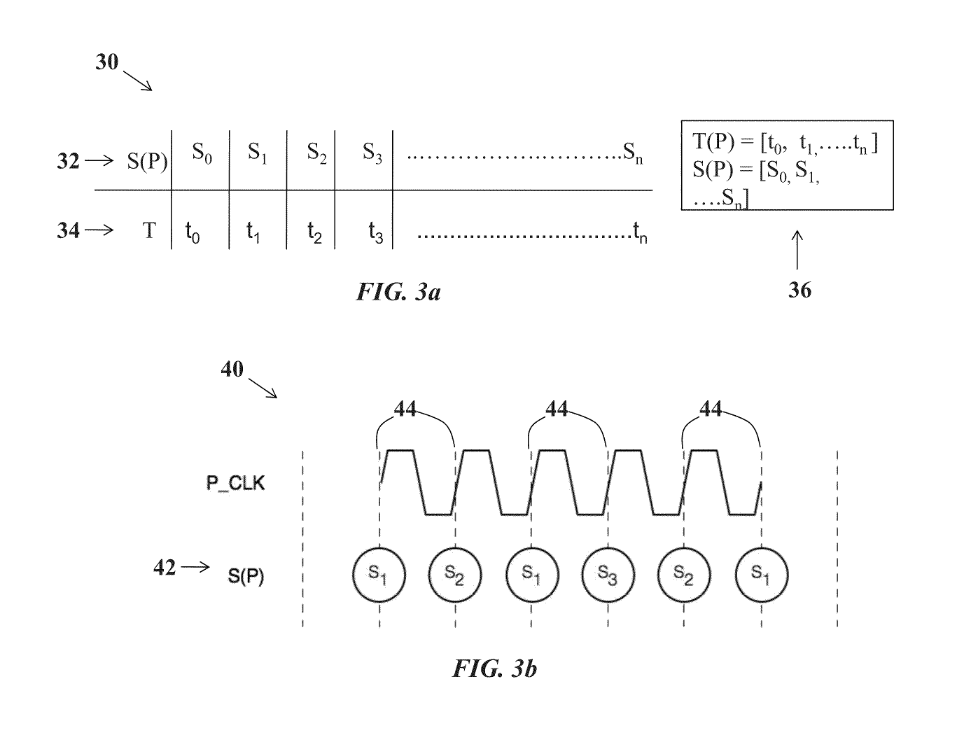

FIG. 3a provides an illustrative example of perspective 30. Perspective 30 changes states 32 at discrete time intervals 34 according to perspective relationships to be discussed herein. Box 36 shows the state set of perspective 30 for all times t₀ to tₙ. FIG. 3b illustrates another example of perspective 40 which may change states 42 at discrete time intervals 44.

A perspective may include an intrinsic and extrinsic state set. An extrinsic state set refers to all the possible states a given perspective may have over the time for which it is defined. The intrinsic state set refers to a reduced state set of a given perspective.

After defining perspectives, their states, state transitions, and their communication relationships, the PML engine may realize the ontology—a consistent definition of objects and their relations. Based on these definitions the PML engine asserts an extrinsic state set for each defined perspective. The extrinsic state set includes all possible states a defined perspective may have. Using known information entropy algorithms such as Huffman coding or arithmetic coding, the PML engine reduces the extrinsic state set to an intrinsic state set. The model may then be instantiated with some perspective for at a given time. The modeler may derive useful information from the instantiation.

A perspective modeling language (PML) engine, which defines the perspective modeling language, may convert the extrinsic state set to an intrinsic state set using known information entropy reducing algorithms such as Huffman coding or arithmetic coding. The PML engine maps user generated information to appropriate perspective classes. Other uses of the PML engine will be enumerated later in the present disclosure.

The intrinsic state S of a perspective at time t depends on its object, environment, and composition relationships. The duration of time t, for a given perspective, is constant for the existence of the perspective and is referred to as the “frequency”.

FIG. 3c shows an exemplary embodiment for defining perspective 50. Fields including name field 52, clock field 58, stream field 54, environment field 60, and composition field 56 define perspective 50. As shown in code segment 76, code lines 62, 64, 66, 70, and 72 define perspective fields. A perception function 74 may utilize these fields to perceive objects as shown by code line 68. A PML engine uses code segment 76 to define perspective 50. FIG. 3c represents only one method for defining a perspective, other methods may be apparent to those having ordinary skilled in the art.

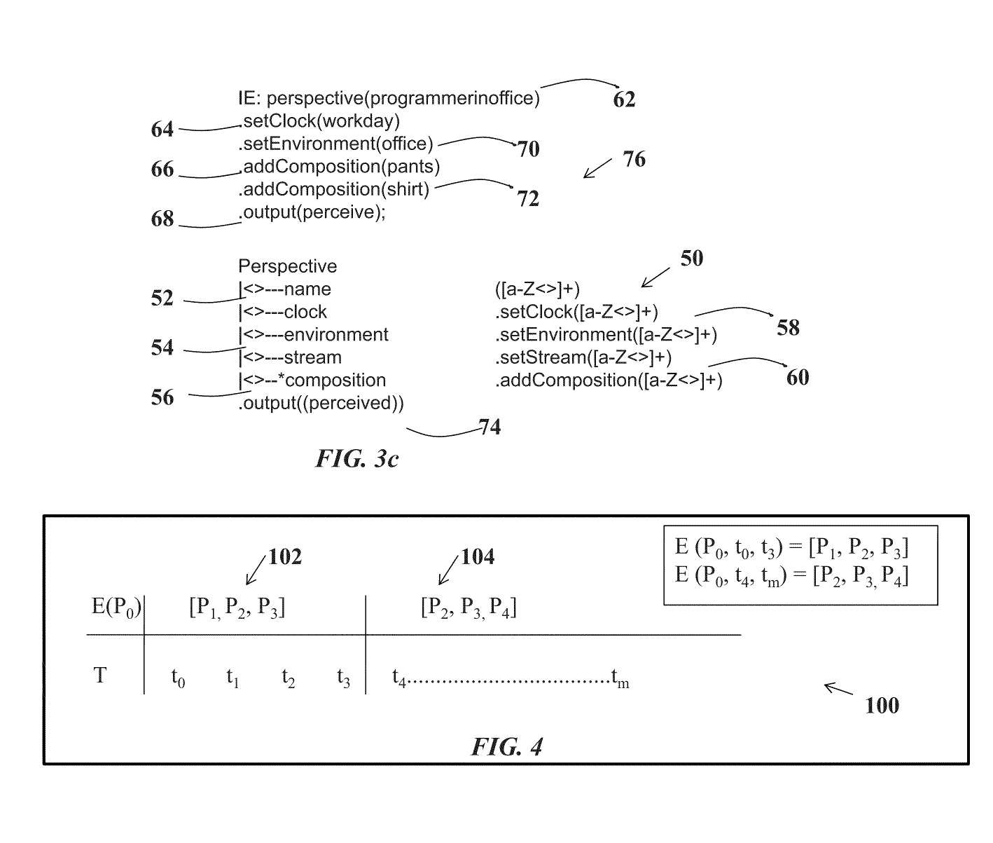

The relationships between perspectives are defined in three ways: “Environment” (E), “Composition” (C) and “Objects” (O). These three types of relationships may also be known together as “semantic communication relationships”. The “Environment” defines the set of related perspectives that form the input of the perspective at a given time t. FIG. 4 graphically illustrates this principle. As shown in FIG. 4, perspective 100 has environment relationships 102 and 104 for times t₀ through tₘ. For times t₀ through t₃, the input to perspective 100 consists of perspectives P₁, P₂, and P₃ or environment relationships 102. For times t₄ through tₘ, the input to perspective 100 consists of perspectives P₂, P₃, and P₄ or environment relationships 104.

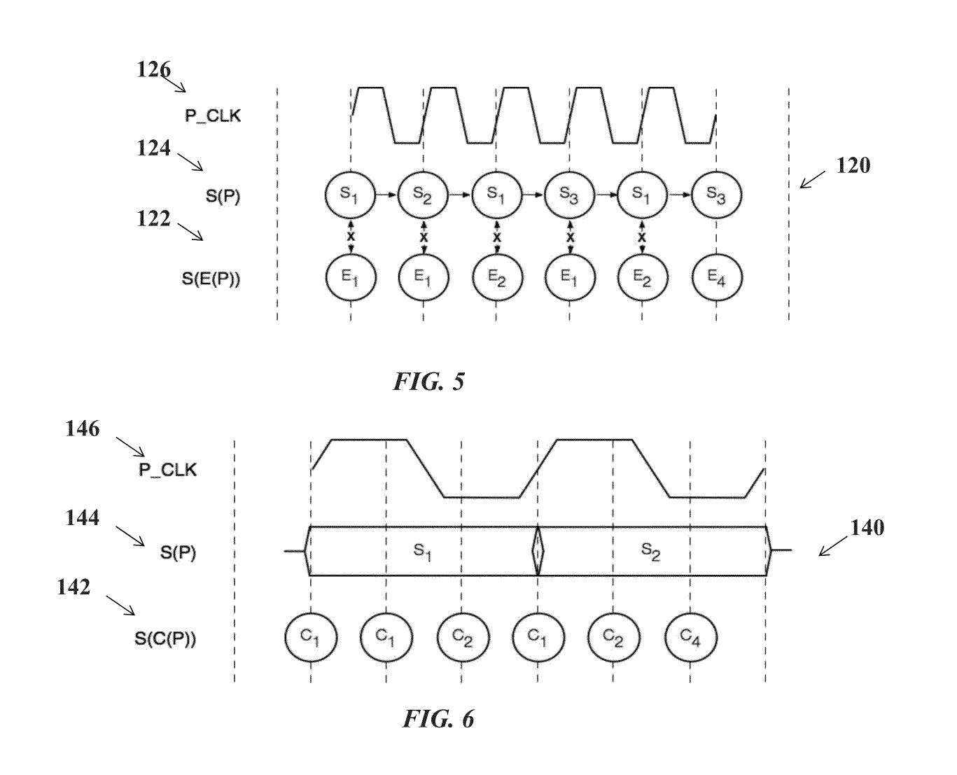

That is for each perspective within E(P, t₁, tⱼ)=[P₀, . . . Pₙ], there exists a set of states S[E(P, tᵢ, tⱼ)]=[S(P₀), . . . S(Pₙ)] such that S (P, tᵢ, tⱼ)×S [E (P, tᵢ, tⱼ)]→S (P, tᵢ₊₁, tⱼ₊₁) for all (tᵢ, tⱼ). FIG. 5 illustrates this function. Environment relationships 122 and perspective 120's clock 126 can affect changes in states 124 of perspective 120 according to environment relationships 122. The state of the environment is the cumulative representation of the state of the perspectives which make up the environment. Thus, the same environment states may lead to different perspective states depending on the perspective clock and cumulative environment states that have occurred.

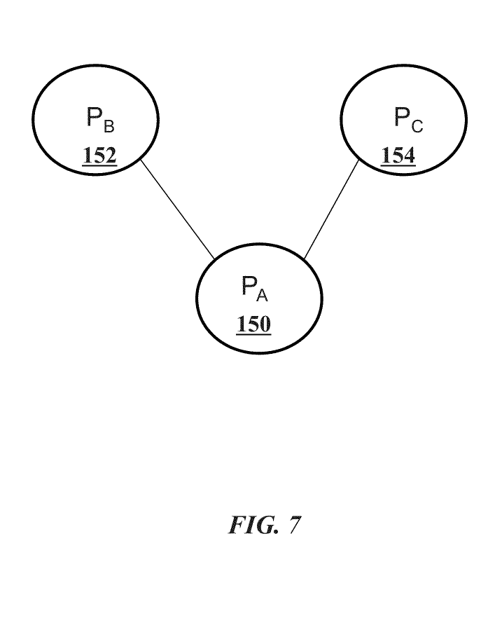

The “composition” set defines the set of all related perspectives that form the structure of the perspective at a given time t. That is, for each perspective within C (P, tᵢ, tⱼ)=[Pₘ, Pₙ . . . ], there exists a set of states S(C (P, tᵢ, tⱼ))=[S (Pₘ), S (Pₙ), . . . ] such that S(P, tᵢ, tⱼ)≡S[C(P, tᵢ, tⱼ)] for all (tᵢ, tⱼ). An example of this function is shown in FIG. 6.

FIG. 6 shows perspective 140 having composition states 142 which define states 144 of perspective 140 at a given time 146.

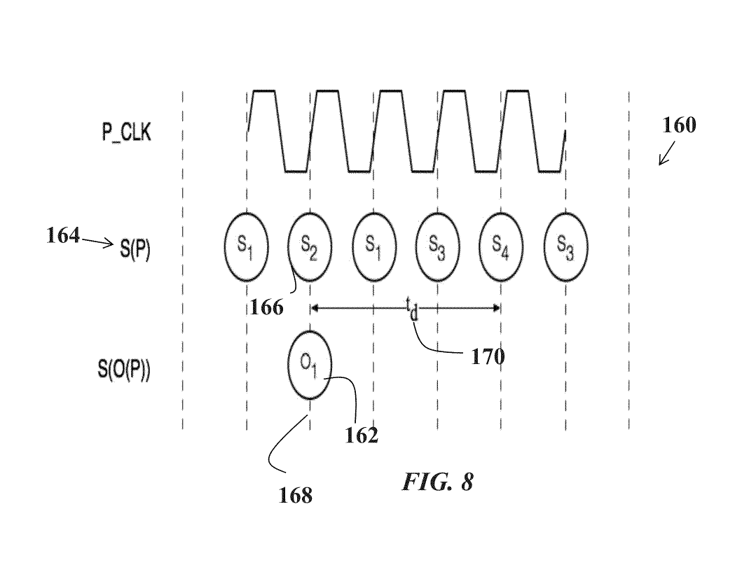

“Objects” define the set of all related perspectives that observe the state of a perspective at a given time t. An illustrative example of this is given in FIG. 7. In FIG. 7, perspectives B 152 and C 154 may observe the state of perspective A 150 at time t. This means perspectives B 152 and C 154 are objects of perspective A 150. Perception of perspective A 150 in perspectives B 152 and C 154 may further result in state changes in these perspectives.

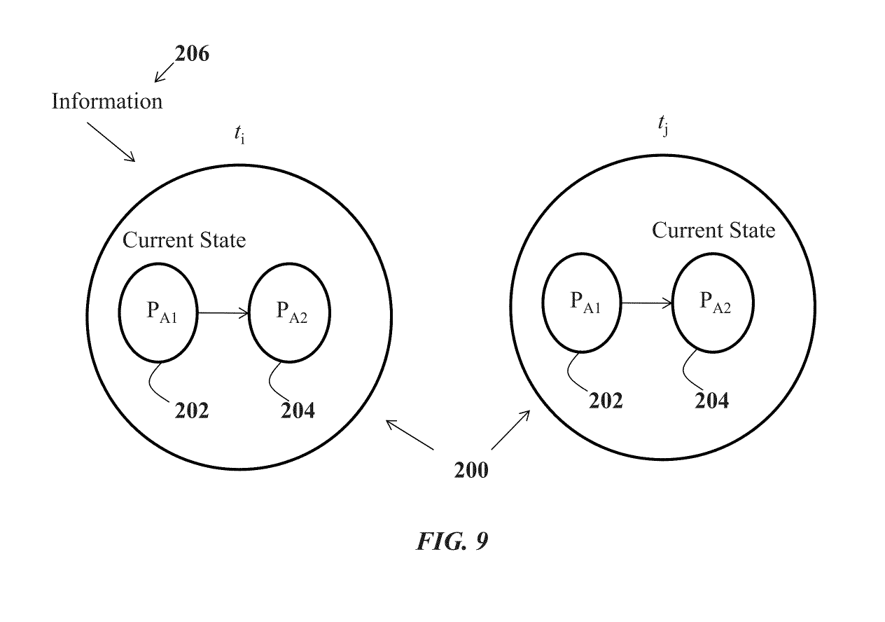

That is, for each perspective with O(P, tᵢ, tⱼ)=[Pₘ, Pₙ, . . . ] there exists a set of states S(O(P, tᵢ, tⱼ))=[S (Pₘ), S(Pₙ) . . . ] such that S(O(P, tᵢ, tⱼ))≡S(P, tᵢ₊₁, tⱼ₊₁) for all (tᵢ, tⱼ). An illustrative example of this function is shown in FIG. 8. FIG. 8 shows perspective 160 having an object relationship. Perspective 160 has states 164. An object perceives perspective 160's state 166 at time 168. The perception results in a corresponding object state 162 in the object. Various perception functions from different objects may result in different object states 162. Object state 162 may last for time td 170 based on the object's clock. Further, a perspective may have multiple object relationships just as a perspective may have multiple environment and composition relationships.

Thus, an object of a perspective may perceive the state of a different perspective. Further, perspective objects may output data onto an information stream. There are many types of object relationships. One specific example refers to control relationships. All relationships of a perspective may be represented in the abstract data type of a perspective.

The stream object provides an environment to the perceptive from the outside world. This object collects outside events and time tuples and puts them into the PML environment format. In one example, the PML engine parses file data, such as may be contained in an XML document, and maps the appropriate data to the PML environment.

“Context” refers to an element of a perspective which may perceive information. Each context may receive only one form of information and for one perspective. Context and information show how a perspective may be formed. A context exists as a set of states and can be further de-constructed in terms of sub-contexts. Context is further described by a perspectives interactions, composition, and communication. Formation of context will be described later in the disclosure.

The term “Language” applies to a finite set of words, each of the same information class, which the context may perceive. The language of a perspective relates to a number of states, state transitions, and accepted inputs which adhere to the rules set in the environment, composition, and object relationships defined for the perspective. The language of a perspective is used to create semantic communication relationships to interact with other perspectives.

In order to define the state of a perspective, in a function known as “perception,” the following process steps are used: For perspective, P, given relationships E(P, tᵢ, tⱼ)=[Pₐ . . . P_{z}], C (P, tᵢ, tⱼ)=[P₁ . . . Pₙ], and O (P, tᵢ, tⱼ)=[P_{α} . . . P_{w}], a state (S) must be determined for SεS (P, tᵢ, tⱼ) for t₁=tₘ and tⱼ=tₙ. It is known: S (P, tₘ₋₁, tₙ₋₁)×S(E (P, tₘ₋₁, tₙ₋₁))→S(P, tₘ, tₙ)≡S(C(P, tₘ, tₙ)), and S(P, tₘ, tₙ)=S(O(P, tₘ+t₀, tₙ+t₀)) where all states sets are probability distributions. The function repeats itself until no change is observed in the perception cycle.

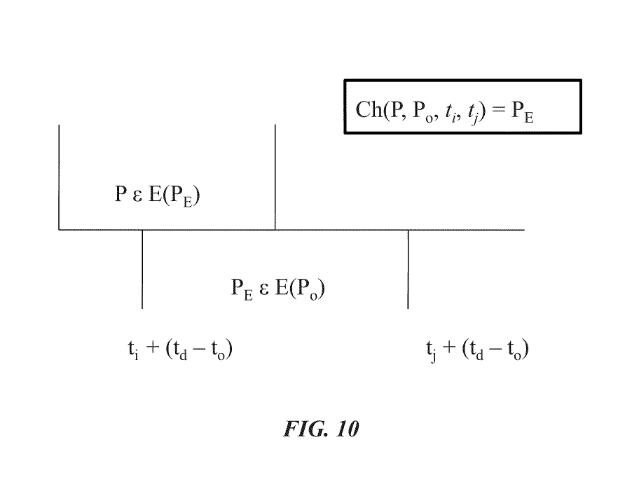

An illustrative example of these functions is shown in FIG. 9. Perspective 200 defined, in part, by states P_{A1} 202 and P_{A2} 204 receives information 206 at time tᵢ. Based on the relationships of a perspective discussed heretofore perspective 200 changes from state 202 at time tᵢ to state 204 at time tⱼ. Thus, [S(E(P, tᵢ, tⱼ))=(information 206)]×[S(P,tᵢ, tⱼ))=(P_{A1} 202)]→[S(P, tᵢ₊₁, tⱼ₊₁))=(P_{A2} 204)]. State P_{A2}εS (P, tᵢ, tⱼ)≡S(C(P, tᵢ, tⱼ)) and P_{A2}εS(P, tᵢ₊₁, tⱼ₊₁) S (C (P, tᵢ₊₁, tⱼ₊₁)). Further, had object relationships for perspective 200 been defined, the perspective states P_{A1} and P_{A2} may result in state changes to the object.

All implementations of a perception function perform three functions. First, inputs to the perspective must be processed. These inputs may include either environmental relationships or inputs from an external data stream. Next, the state of all related perspectives must be represented. Finally, the state set of a perspective for a given clock cycle must be narrowed down based on relationships of the perspective and information received as inputs. This is known as the intrinsic state set. An intrinsic state set of a perspective may be defined based on the extrinsic state set of the perspective.

The function of “perception” can be evaluated in several ways. A perception cluster of a defined perspective class is the subset of state changes that occur as a result of the same perception function.

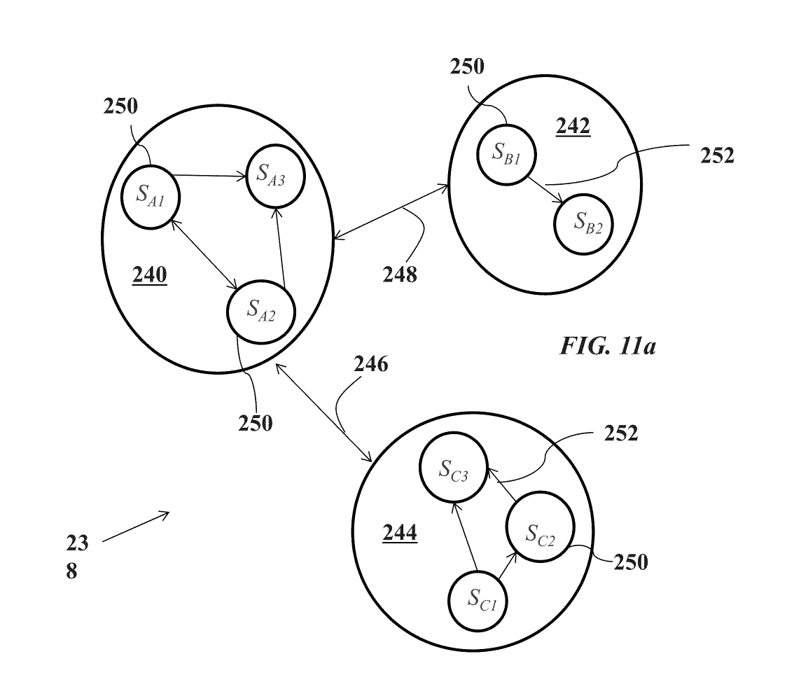

There is also an inferred relationship between perceptions. In all perspective-object relationships, a “channel” is required to send information as an input to the object. For P, the perspective, and P₀εO(P, tᵢ, tⱼ), we can consider a first order “channel” as follows: S(P, tᵢ, tⱼ)≡S[O(P, tᵢ, tⱼ)]=S(Pₒ, tᵢ+tₒ, tⱼ+tₒ). Therefore: Ch (P, Pₒ, tᵢ, tⱼ)=P_{E} iff PεE(P_{E}, tᵢ, tⱼ) AND P_{E}εE[Pₒ, tᵢ+(t_{d}−tₒ), tⱼ+(t_{d}−tₒ)] where t_{d} is the frequency of P_{E} and tₒ is the frequency of Pₒ. The channel links related perspectives together to further define each perspective, as all perspectives are defined by their relationship to other perspectives. An illustrative example of a channel linking perspectives together is shown in FIG. 10. A channel is only one of several possible inferred relationships, which also include: n-order compositions, n-order objects (also called interactions), and n-order temporal relationships.

A channel between perspectives and objects enables communication. The term “word” refers to some state of an environment a perspective perceives through a perception for a given clock cycle. The term “information” refers to a series of words perceived by a perspective over a given time range. Thus, the term word refers to a discrete unit of information. A context defines a word or information onto a communication channel, enabling perception.

All sets of perceptions are taken against the context of the object, which is equivalent to “language” of a typical perspective. “Objects” form a consistent organization of a set of perspectives which is perceived by a perception. Each state of the organization of the object may be defined as a state of the context of the perspective, as perceived through a word of information. An object is defined onto a memory system by a set of contexts or sub-contexts.

The term “resources” pertains to a set or subset of all objects referable by context in order to make a perception.

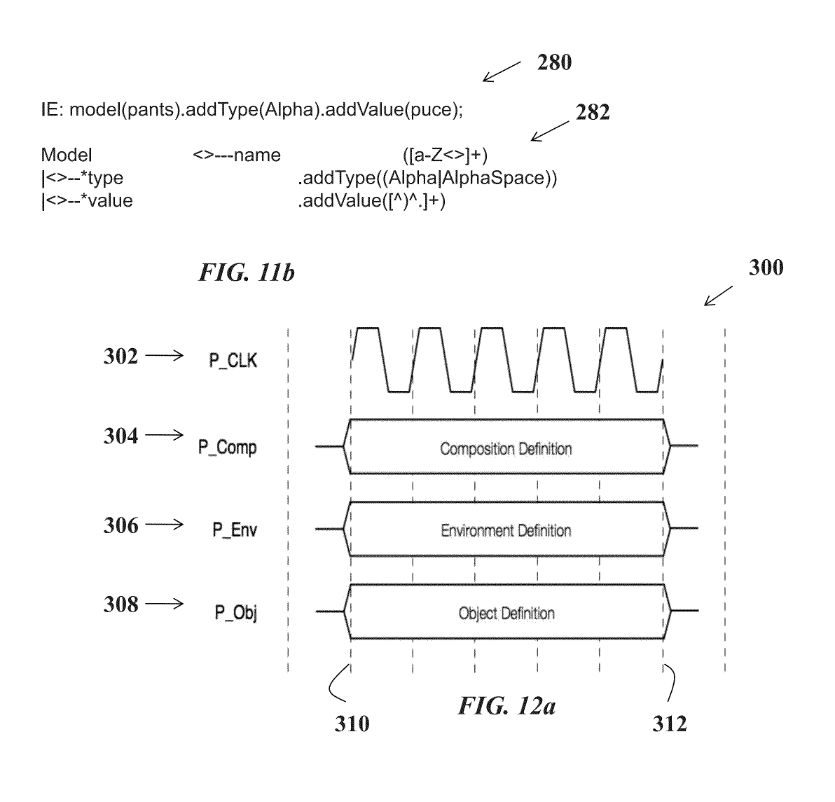

PML allows users to create and define three classifications of relationships between perspectives. These are composition, environment, and object relationships as defined earlier in the disclosure. The simplest perspective model, a functional model, consists of only environment relationships wherein the state changes are consistent with the environment relationships of the perspective. FIG. 11a shows functional model 238 having perspectives 240, 242, and 244 each having states transitions 252 dictating states 250 for a given time t. Further, state transitions 252 conform to environment relationships 246 and 248. For example, state transitions 252 for perspective 240 must conform to both environmental relationships 246 and 248. While state transitions 252 for perspective 242 conform to environmental relationship 248. State transitions 252 in functional model 238 may be deterministic or Bayesian. In one application, a functional model may be used to model and observe the sequence of events of a process. A functional model differs from a finite state machine. In a functional model, state transitions for an input may only be defined for one clock cycle.

FIG. 11b illustrates exemplary code snippet 280 used to create a functional model and the mapping of the data to model class 282.

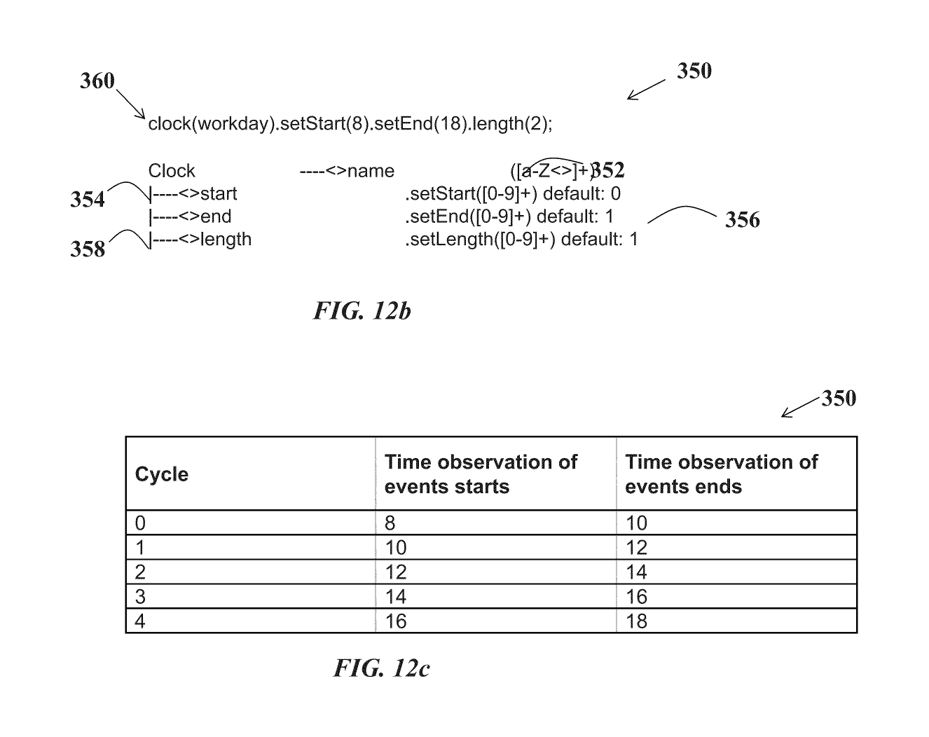

Clocks are used in PML to provide a time frame for object, composition, and environment relationships. FIG. 12a shows perspective 300 having its own clock 302, composition relationships 304, environment relationships 306, and object relationships 308. Times 310 and 312 designate the times for which relationships 304, 306, and 308 remain valid. Clock 302 passes through five (5) cycles between times 310 and 312. Composition, object, and environment relationships do not necessarily need to be valid through the same time, but may have a different time length consistent with the definitions of those relationships.

FIG. 12b illustrates a clock created in PML and the appropriate data mapping by the PML engine. Clock 350 may be created using code 360. The PML engine may then map values to the appropriate fields. In this case, The PML engine sets name 352 to ‘workday’, start time 354 to ‘8’, end time 356 to ‘18’, and length 358 to ‘2’. FIG. 12c graphically shows the cycling of clock 350. Clocks provide a “window” of time that events are observed by other PML objects. Each clock may define its own length as shown in FIG. 3c.

The application of all three relationships, which can be defined in perspective, interaction, communication, and composition diagrams, allow for the modeling of complex systems. The PML engine uses the data provided in these diagrams to simulate models, to process queries, and to provide further information about the system being modeled.

There are several other ways to create all PML relationships including an object oriented style of coding, design patterns, and abstract machines. Still other methods for defining these relationships may be known to those having ordinary skill in the art.

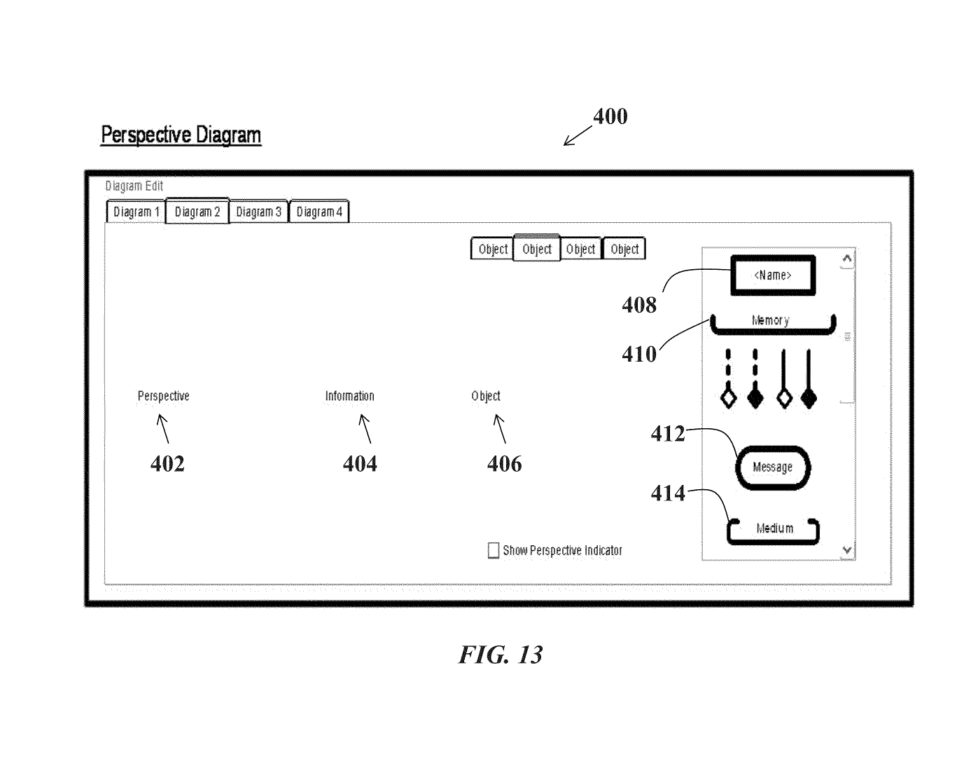

FIG. 13 illustrates an exemplary perspective diagram 400 which may be used to define a perspective 402, its object relationships 406, and information 404 it uses to communicate with objects. Perspective diagram 400 operates after a user provides perspective name 408, functional mode 1410 on which it acts, word 412 which includes data relating to perspective relationships, and communications channel 414 by which information is passed.

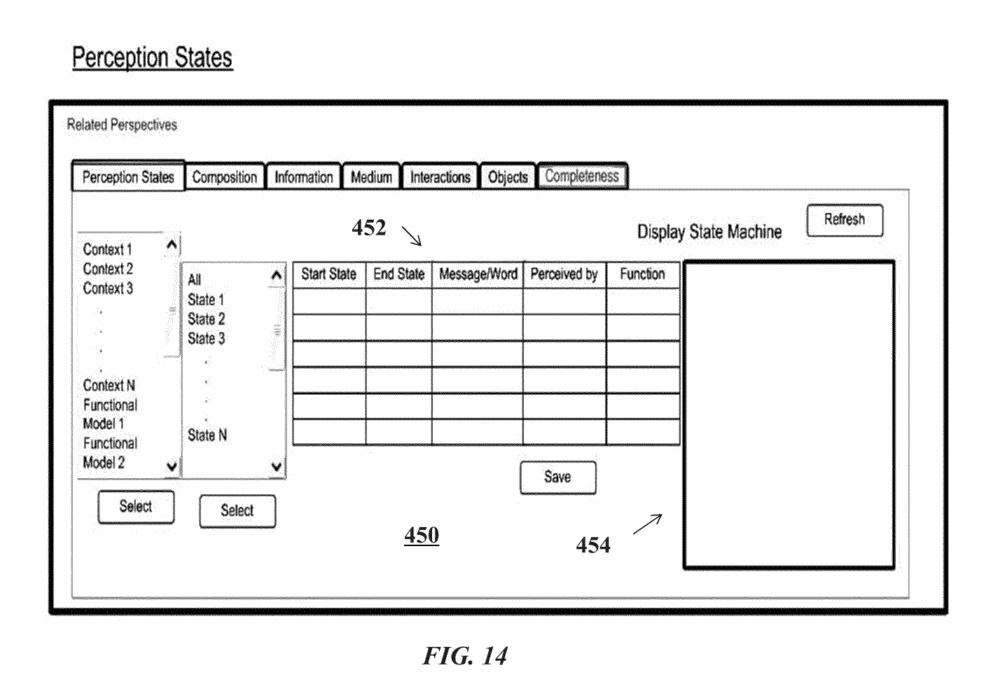

Perception states diagram 450, illustrated in FIG. 14, may be used to further define a perspective. As shown in FIG. 14, a user may input state information in state information area 452. This information will be displayed in state machine area 454.

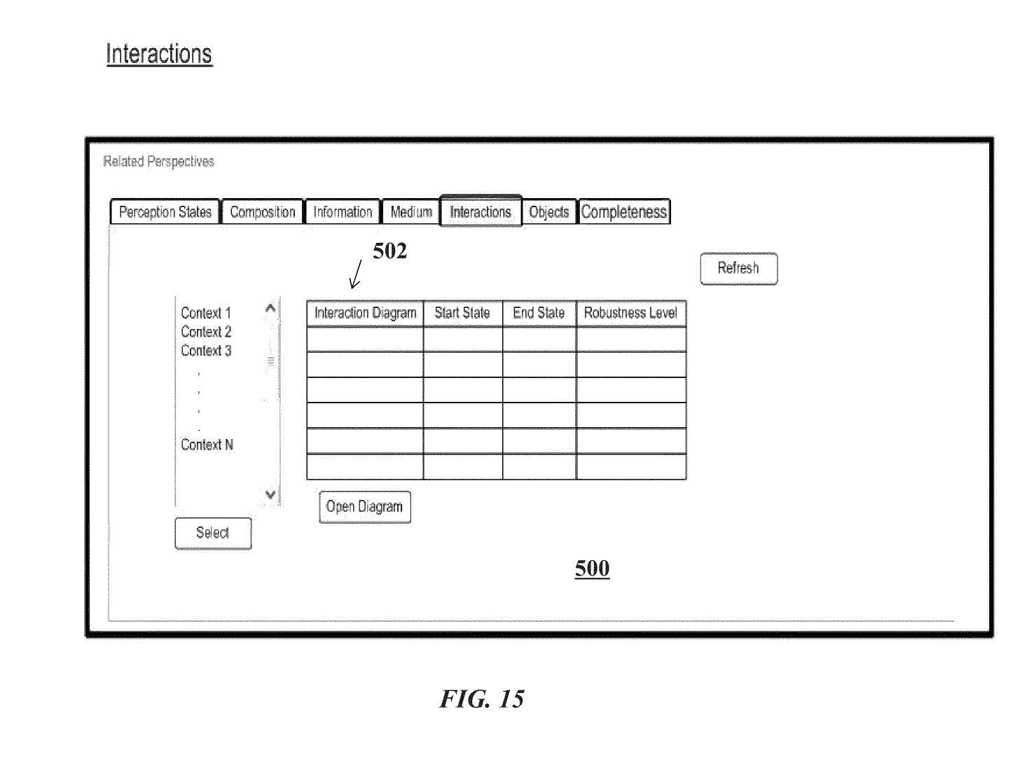

An interaction model may be used to relate two (2) or more perspectives through object relationships. FIG. 15 shows interaction diagram 500 which may define an interaction model. Interaction diagrams having definition area 502 provides information from which the PML Engine may define an interaction model.

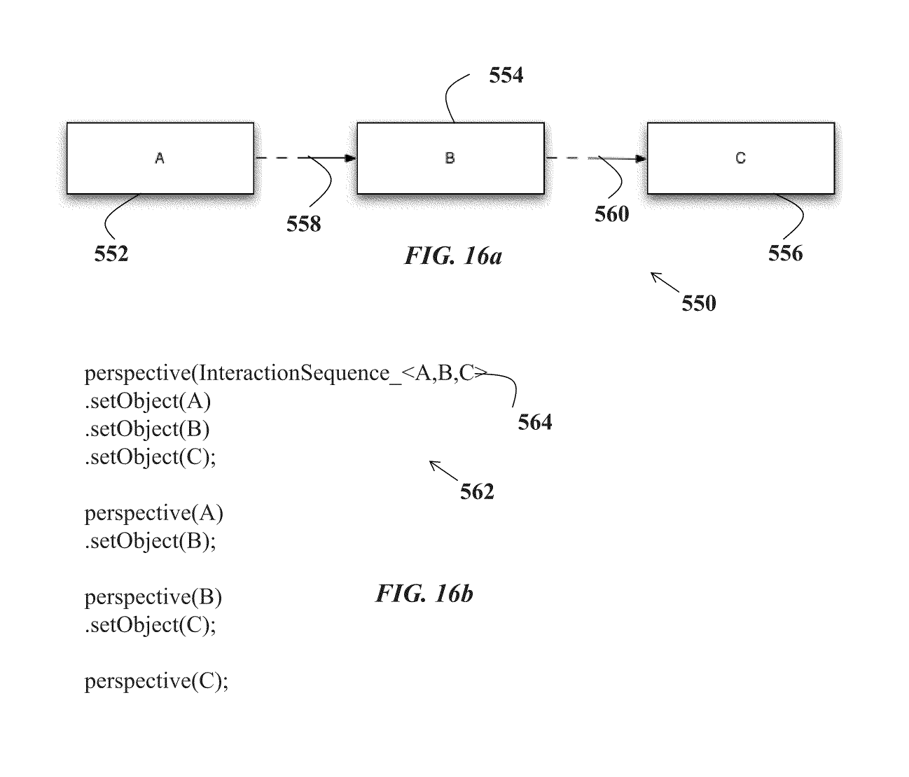

FIG. 16a shows an exemplary interaction model 550. perspective A 552 has object perspective B 554 through object relationship 558; likewise, perspective B 554 has object perspective C 556 through object relationship 560.

FIG. 16b shows code 562 which may define interaction model 550. As shown interaction sequence perspective class 564 observes all perspectives in the sequence. This may also be defined through interaction diagram 500 of FIG. 15. In this case, the PML engine may create perspective class 564. It should me noted that perspective A 552 may interact with perspective C 556 through perspective B 554.

Communications channels must exist for the object relationships to hold. These communications channels may be automatically defined or user defined as will be described later in the present disclosure. It should be noted that a time delay occurs between interactions of perspective A 252 and perspective B 254. Another time delay exists between interactions of perspective B 254 and perspective C 256. Therefore, a time delay, equal to the sum of the time delays mentioned heretofore, also exists between perspective A 252 and perspective C 256. The time delay results from the object relationship definition described heretofore.

An interaction model for a given perspective can consist of one or more interaction sequences. Thus, the interaction model of a perspective shows all the object relationships of that perspective.

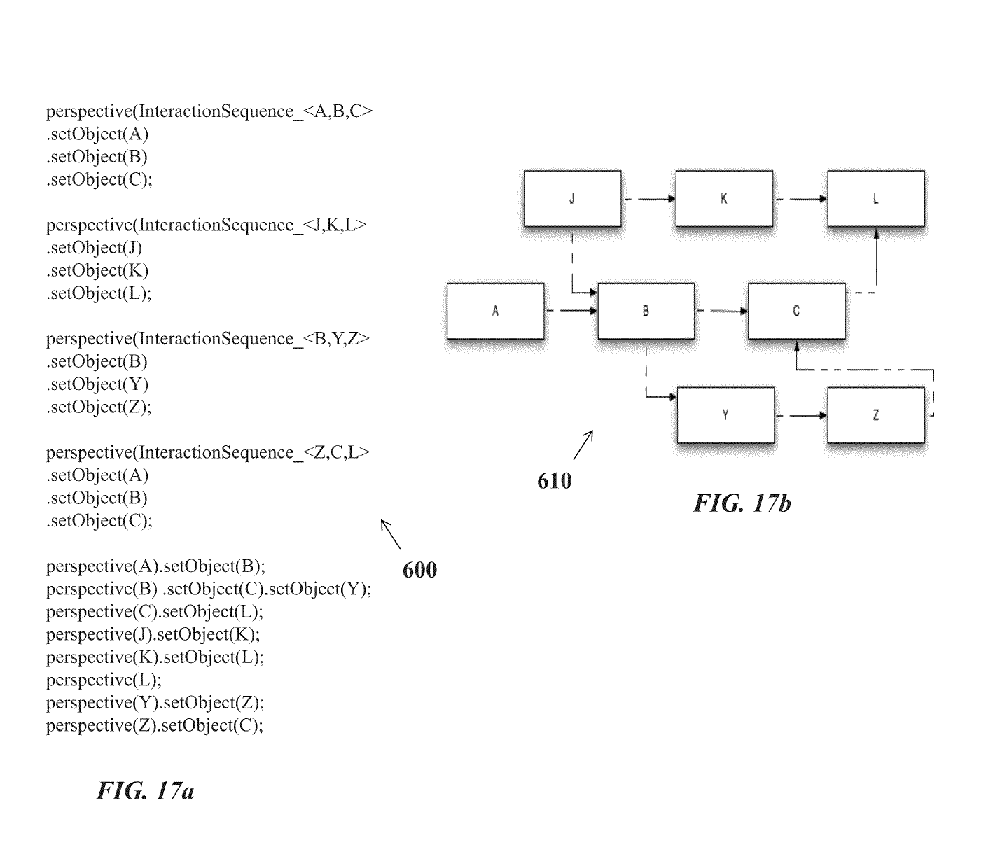

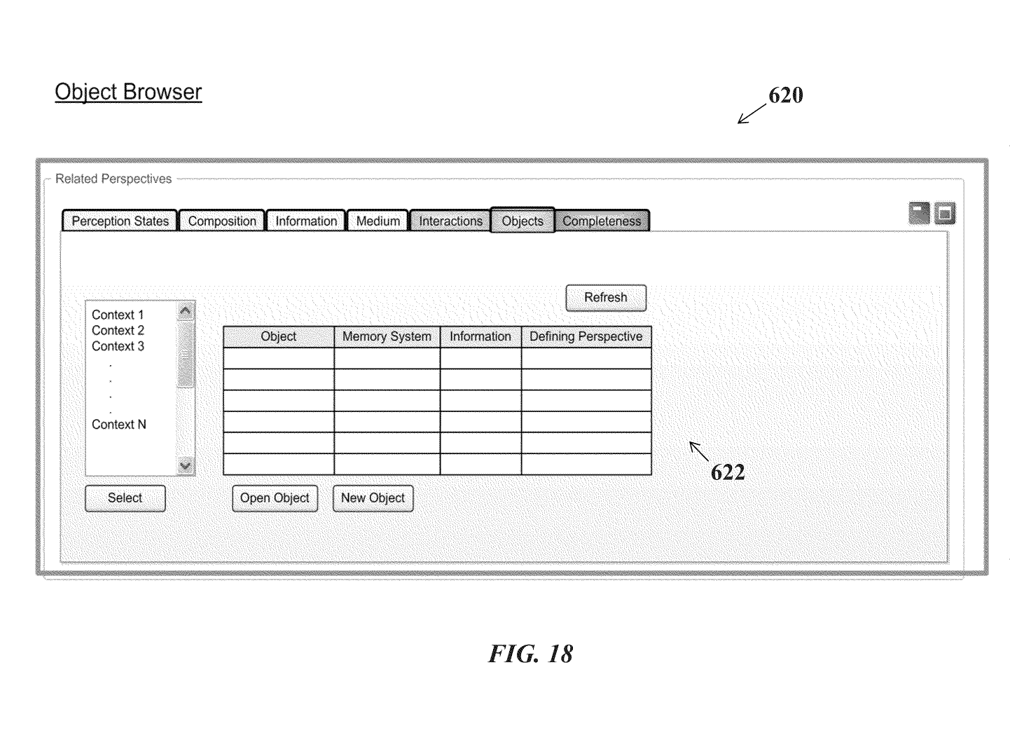

The set of all interaction models in the PML engine for all perspectives is referred to as the interaction graph. In this case, a directed graph is formed where each perspective acts a node on the graph, while the edges are composed of each defined object relationship. FIG. 17a shows code 600, which may be user generated, used to create an interaction graph. FIG. 17b shows interaction graph 610 generated by code 600. Interaction graph 600 shows all object relationships defined for a given model. FIG. 18 shows Object definition diagram 620 which may also be used to define object relationships through Object definition area 622.

The interaction graph can also be used to induce graphs that detail message passing between perspectives, as well as the channel relationship between perspectives. The interaction graph of a perspective consists of a query for all interaction sequence perspective classes.

Interaction models and graphs characterize a number of systems efficiently including resource expenditure models. Interaction models and graphs are created by the PML engine based on data from the interaction diagram or user generated code. Although these relationships are described with reference to graphs wherein the perspectives are nodes of the graph and objects are edges, the PML engine could define these relationships in a number of other ways. The specific reference to a graph implementation is not intended to limit the disclosure.

Communication diagrams, defining communication channels between perspectives, objects, and their environments provide information about the efficiency of communication in a system. Three different communication channels (asynchronous output, asynchronous input, and synchronous) model the exchange of information between perspectives, objects, and their environments.

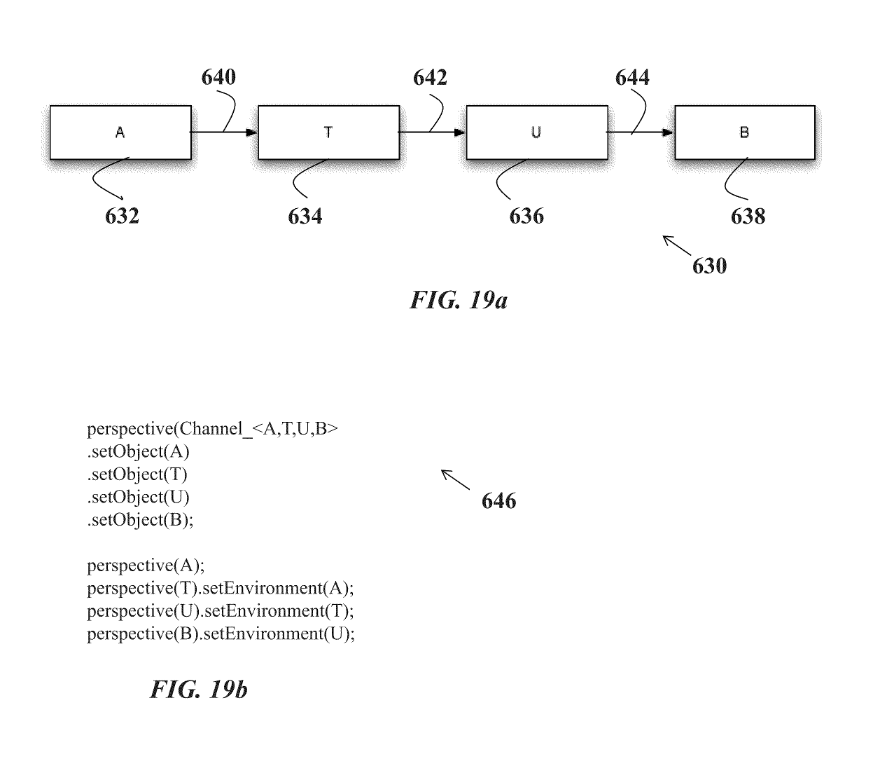

The asynchronous output communication channel relates a sequence on environmental relationships in order to describe the information output relative to a particular perspective. FIG. 19a provides an illustrative example of asynchronous communication channels. Communications model 630 describes communications relationships between perspectives. Perspective A 632 may output information to perspective T 634 through asynchronous output communications channel 640. Perspective T 634 may output information to perspective U 636 through asynchronous output communications channel 642. Perspective U 636 may output information to perspective B 638 through asynchronous output communication channel 644. FIG. 19b provides PML code 646 that may be used to create asynchronous output communication channels.

From an asynchronous output communication channel, the PML engine can infer the potential for an object relationship from any of the perspectives within the channel. The PML engine can also infer relative temporal state relationships from within the channel. In this scenario, we have crated a perspective class that has been previously defined to measure the channel relationships between four (4) perspectives.

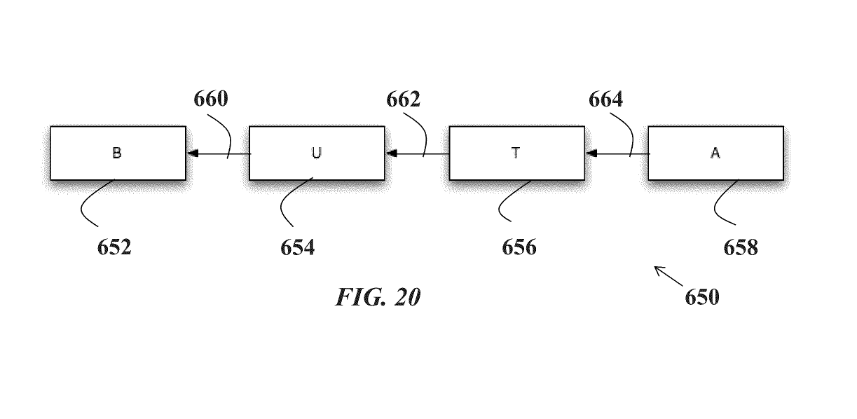

Asynchronous input communication channels characterize the information exchanges, defined by environment relationships, between perspectives. Asynchronous input communication channels are asynchronous output communication channels but relative to the inputs of a channel to a defined perspective. FIG. 20 provides an illustrative example of asynchronous input communication channels. FIG. 20 shows communications model 650. In this case, perspective B 652 receives input from perspective U 654 through asynchronous input communications channel 660. Perspective U 654 receives input from perspective T 656 through asynchronous input communications channel 662. Perspective T 656 receives input from perspective A 658 through asynchronous input communications channel 664.

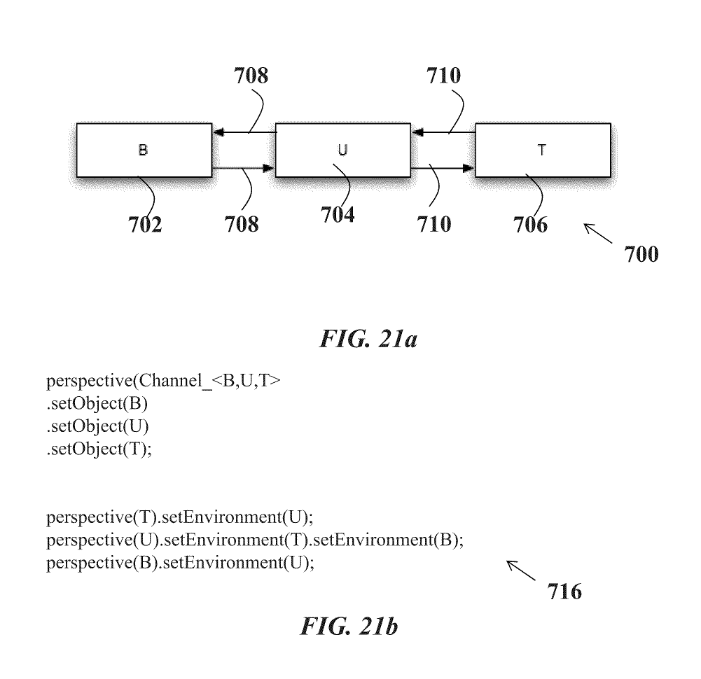

Asynchronous output and input communication channels along with the language of each perspective, describe synchronous communication channels. FIG. 21a provides an illustrative example of a synchronous communication channel. Perspective B 702, perspective U 704, and perspective C 706 may communicate through synchronous communication channels 708 and 710. FIG. 21b provides PML code 716 which may create the synchronous communication channels of FIG. 21a.

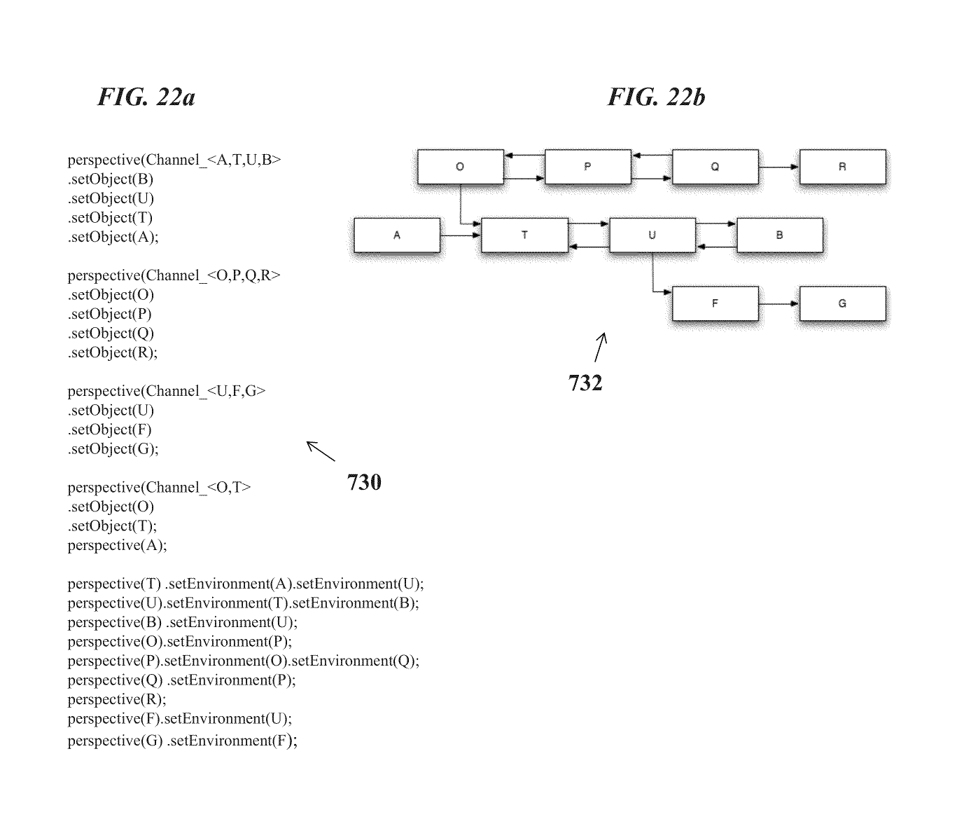

The network graph describes the channel relationships for all perspectives defined in the system. The network graph can be realized by creating a query for every channel described in the system. Network graphs are an important tool used by the PML engine to simulate and query information. FIG. 22a provides code 730 which may be used to define network graph 732 of FIG. 22b. As noted earlier, the implementation of these relationships through graphs provide only one possible implementation the PML engine may use.

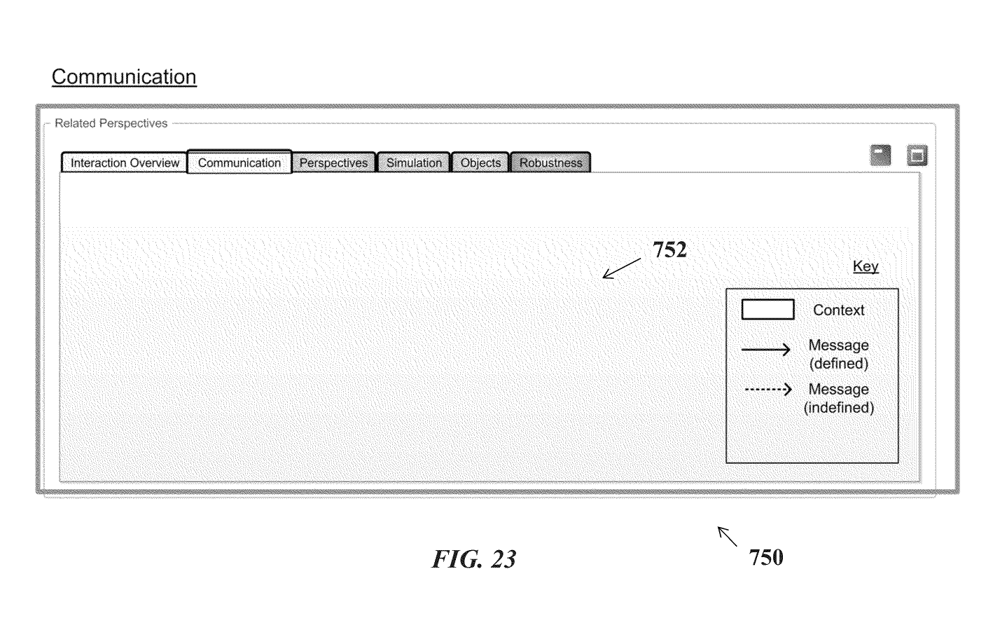

FIG. 23 illustrates a user interface for a communication diagram that may also be used to provide data regarding communication relationships. FIG. 23 shows communication diagram 750 having communication definition area 752 from which environment relationships may be defined.

Composition trees and graphs of and between perspectives can be defined by composition diagrams. Two main forms of composite relationships, hierarchical abstractions and hierarchical materializations, are used to form a composition tree.

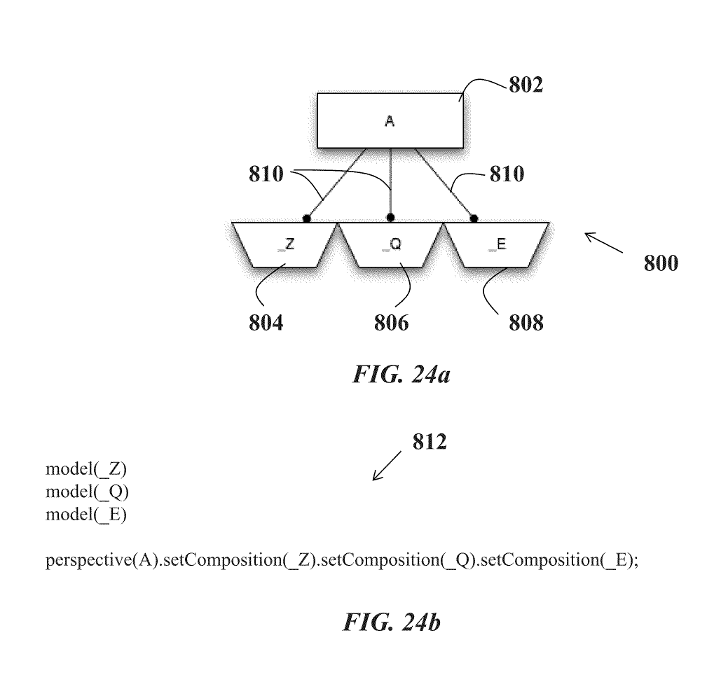

Hierarchical abstractions provide one to N, one way relationships between perspectives and models. Hierarchical abstractions describe a perspective from the viewpoint of its composite functional models or perspectives. FIG. 24a provides an illustrative example of hierarchical abstractions. FIG. 24a shows composition tree 800 in which perspective A 802 abstracts functional models Z 804, Q 806, and E 808 through hierarchical abstractions 810. FIG. 24b provides code 812 which may define composition tree 800 of FIG. 24a. It should be noted that composition tree 800 only shows 1^{st} level hierarchical abstractions 810 of perspective A 802, whereas a full composition tree would show the entire compositional lineage of perspective A 802.

In one example, a primitive device such as a memory system may be defined as a perspective in PML and the file data that resides on the memory system may be realized as a series of hierarchical abstractions from the memory system.

The hierarchical materialization describes the 1^{st} level compositions of a defined perspective, from the viewpoint of that perspective. Thus, hierarchical materializations represent the opposite of hierarchical abstractions.

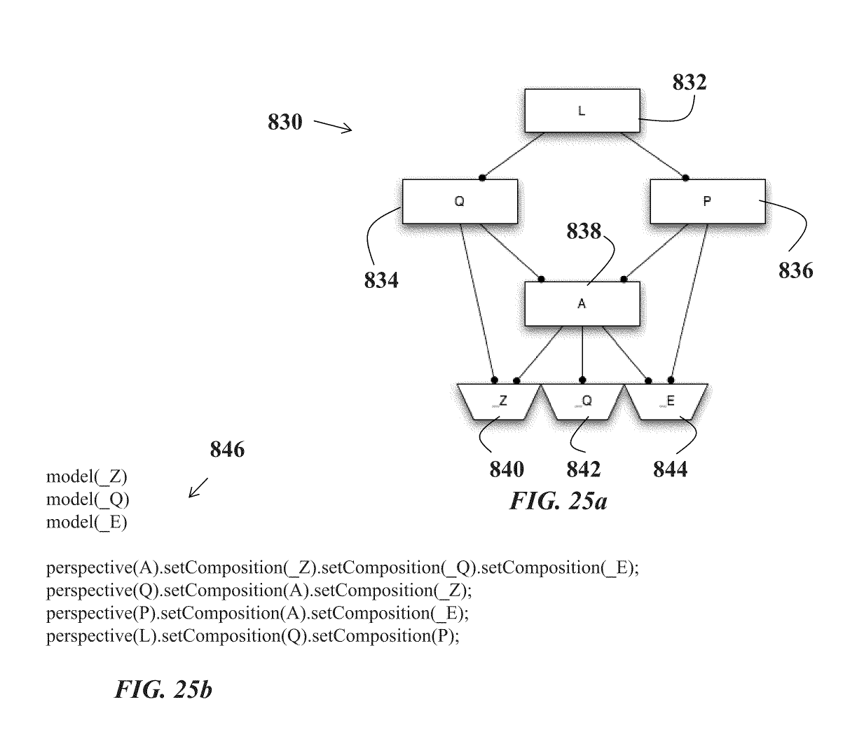

Taken together hierarchical materializations and abstractions describe composition trees. A composition tree describes the entire compositional lineage of a defined perspective class. FIG. 25a provides an illustrative example of a composition tree. Composition tree 830 shows compositional relationships of perspective L 832. Perspective A 838 hierarchically abstracts functional model Z 840, Q 842, and E 844. Further, perspective Q 834 hierarchically abstracts perspective A 838 and functional model Z 840. Perspective P 836 hierarchically abstracts perspective A 838 and functional model E 844. Perspective L 832 hierarchically abstracts perspective Q 834 and perspective P 836. FIG. 25b provides PML code 846 which defines composition tree 830 of FIG. 25a.

The PML engine uses information provided in the composition diagram to derive composition graphs which describe N to N composition relationships between perspectives. The composition graph defines the lineage of compositions for all perspective classes in the system. Composition graphs are used by the PML engine during simulation. Again, composition graphs represent only one possible implementation the PML engine may use and are not meant to limit the scope of the disclosure.

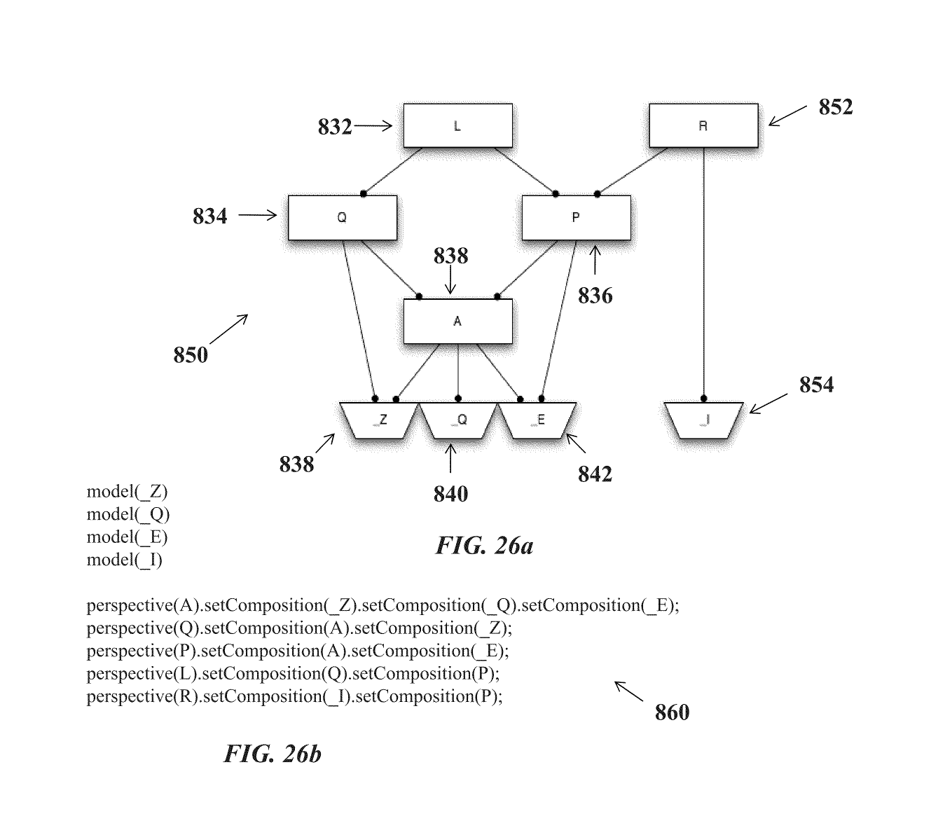

FIG. 26a provides an illustrative example of a composition graph. FIG. 26a shows composition graph 850 having composition tree 830. Further, composition graph 850 shows perspective R 852 and functional model 854 to illustrate all compositional relationships of the defined system. FIG. 26b provides code 860 which defines composition graph 850.

Interaction models determine object relationships of a perspective, communication channels determine environment relationships of a perspective, and composition trees determine the compositional relationships of a perspective. Further, object, environment, and composition relationships for all perspectives may be defined by the interaction graph, network graph, and composition graph. All graphs taken together, referred to as the PML ontology, form a consistent system of rules allowing efficient communication and processing of information.

The context of a perspective in PML is defined as the union of all interaction models, communication channels, and composition trees defined for a given perspective. The context may also be formed by filtering interaction, network, and composition graphs for a given perspective. Both methods give the same result.

Context must also account for the order and direction of each relationship. For instance, a composition relationship that is first order would contain all perspectives defined within the perspective's composition definitions. A 2^{nd} order composition set would include 1^{st} order compositions and the compositions of 1^{st} order compositions. A composition could also have an order of −1, denoting Perspectives that include this perspective as a composition.

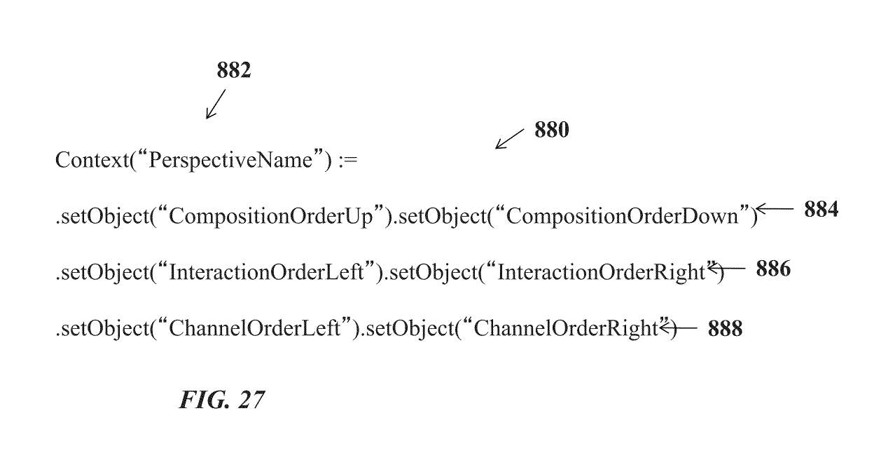

FIG. 27 provides code template 880 for forming context. Thus, direction and order for all relationships are defined when forming context. FIG. 27 shows line 882 defining a context for a particular perspective. Line 884 defines compositional relationships and their order (n^{th} order hierarchical abstraction, n^{th} order hierarchical materialization). Line 886 defines object or interaction relationships and their order. Line 888 defines environmental or channel relationships and their order (n^{th} input, n^{th} order asynchronous).

For each state value that is valid for a perspective, we know that the context and every member of the context has a state definition for a given clock cycle that defines that perspective. The state transition of the context at any given time is defined as the perception function for a Perspective.

Using the information provided in the diagrams, the PML ontology which realizes the relationships between perspectives can be created by the PML engine. The PML engine aggregates and defines all Perspectives and their relationships, in terms of a graph, onto computer memory, wherein each context of a perspective definition terminates in a functional model. As mentioned earlier in the disclosure, graphs provide only one possible implementation the PML engine may use, other methods for defining the relationships may be known to those having ordinary skill in the art.

Thus, the states within a context are defined and a language model is created for perspective classes within a context. During simulation, the graph of the PML Ontology is used to determine valid states based on a perspective's relationships. The PML engine may realize this graph in a number of ways such as an abstract data type. Incoming data may be processed by instantiating and mapping it to the graph of the PML ontology.

The PML engine uses systems libraries to parse the incoming data and map the information to a PML ontology. The systems libraries verify the time duration of a perspective, its relationships, and then write that information into a PML ontology useable by the PML engine. The PML engine may assert an instance of a perspective, for some time range, by defining that perspective's state. The PML engine may also infer an instance of a perspective, for some time range, based on the occurrence of a perception function. The systems libraries are further used by the PML engine to manage memory before and during simulation.

As used herein, type-0 perspectives form the most common form of perspective and each type-0 perspective perceives the environment through a context. A type-1 perspective can define another perspective as an object and observe its state. A type-2 perspective perceives a perspective through a context by defining an object, perceiving its context, defining its environment, and defining the object's interaction with the environment.

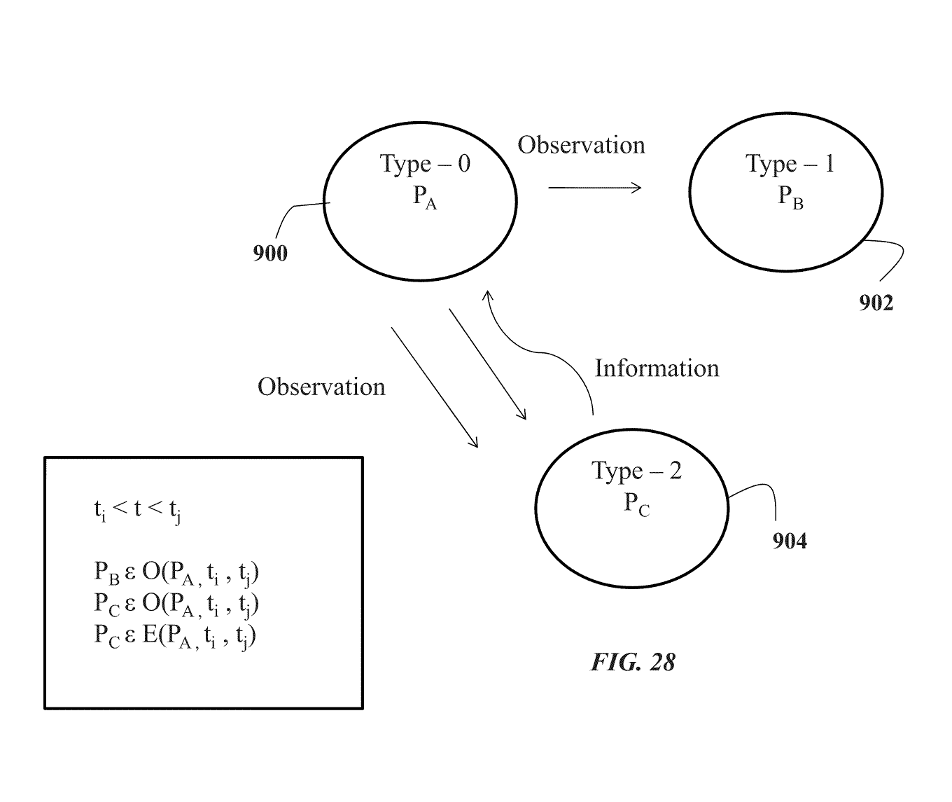

FIG. 28 shows perspectives A 900, B 902, and C 904 communication through observation and sending of information. perspective A 900, a type-0 perspective, may only observe/perceive other perspectives through a context. perspective C 904, a type-2 perspective, may send information to other perspectives.

Using diagrams to model a system in terms of environment, composition, and object relationships, several types of Nth order relationships can be constructed. Although, this list could be infinite only perception, stored perception, expression, control, communication, and simulation Nth order relationships will be discussed. Perception, stored perception, expression, control, communication, and simulation relationships abstract from previously described object, composition, and environment relationships. For example, in a control relationship an object may control the state of another perspective or object based on a defined communication relationship and its state.

For instance, control, communication and simulation are all facilitated by defined communication relationships (above), and then combined with state equivalencies. Stored Perception and Expression relate a defined compositional relationship with a defined environmental relationship.

A perception relationship allows a perspective to receive information and perform a perception function, defined by an object or environment relationship. A perception relationship is a core function; therefore, a relationship that any perspective may have with any other perspective.

Expression and stored perception relationships define two types of first order relationships. Only type-1 or greater perspective may have first order relationships. Expression relationships occur when a context interacts with its environment, usually to send information, through a set of sub-contexts. A stored perception relationship occurs when a perception is stored onto a functional model in a state that remains constant until after the location of the stored perception is changed by a command.

Control, communication, and simulation relationships are types of second order relationships. A control relationship occurs when a context controls states through a set of perceptions in coordination with a negative feedback loop, the perceived state of an object, and the goal state of an object. Control may be realized as a function of expression, feedback (ongoing perception) and time. Control allows an object to interact (through a feedback loop) with an interface, that creates and reads a stored perception. Communication involves the exchange of information between two objects, such that each object has a semantic understanding of the information through a common protocol.

Communication may be realized as a function of expression, perception, feedback and time. Communication involves an object interaction (with open feedback) with another object, through a common protocol and a representation upon a common transmission medium. Each object must perceive and express based on a stored perception, which realizes the protocol.

Simulation relationships allow one perspective to simulate another realizing its language over a given time range.

The ultimate goal of PML, to empower modelers to more accurately and efficiently model a system, is realized through a number of simulations that a defined PML would allow the user to create. One such simple simulation allows a modeler to examine scenarios that occur as a result of a perspective achieving a goal state. The simulation will display the temporally indexed sequence of states each Context existed in while the goal state was being achieved. The temporally indexed sequence of states may be graphically displayed in a number of ways. This allows for useful results pertaining to the sequence of events. A useful application sequential simulation is computer forensics, where a need exists for modeling tools, which can methodically model the temporal relationships between memory and devices in a computer or computer network.

Queries in the PML provide another useful way to ascertain information about the system. A query is executed by matching an instantiation of a context against stored asserted or inferred instances of that context. A query can be used to form behavior models, which describe the language of a perspective over a given time range, by instantiating the language of a perspective.

A temporal visualization interface displays a folded visualization of a timeline describing the state sets of a number of perspectives over a time range, each value consistent with the PML relationships of each perspective. Other information relating to contexts, state transitions, or language may also be displayed. The temporal visualization interface may be realized as a graph of edges and nodes, wherein the edges are perspective relationships and the nodes are perspectives, displayed over time.

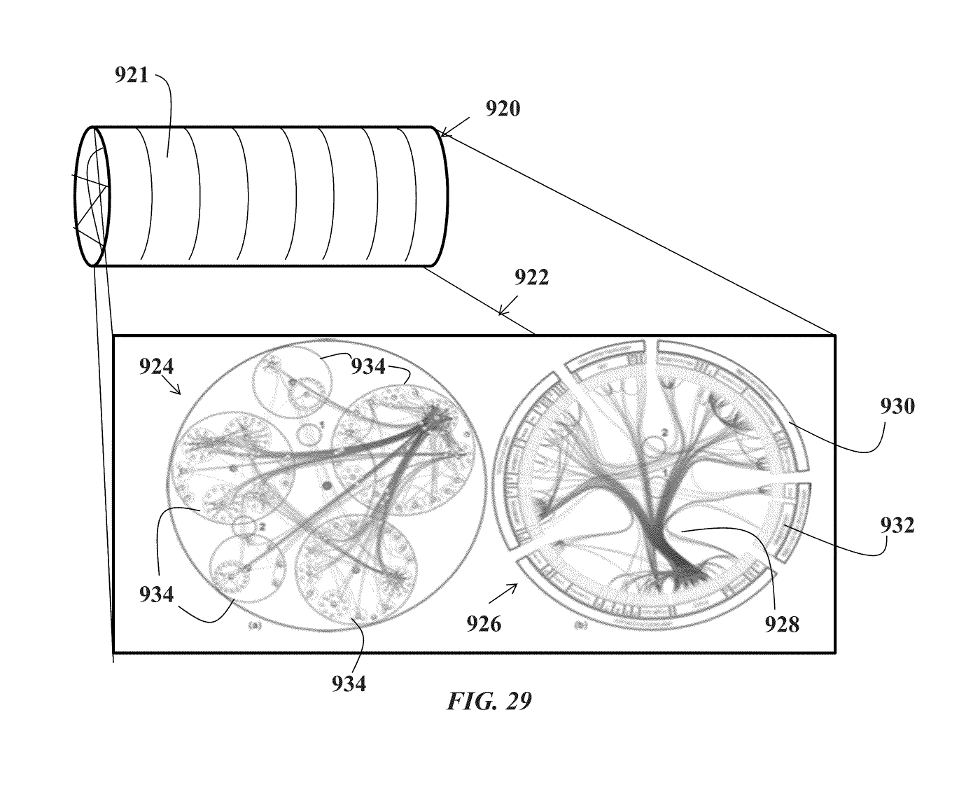

FIG. 29 shows an exemplary temporal visualization interface 920. Temporal visualization interface 920 shows information regarding perspectives and their relationships over the entire life of the PML ontology. Each slice 921 shows information regarding perspectives and their relationships over a time range. In this example, the model has been sampled eight (8) times. Other sampling rates could determine further patterns.

Temporal visualization interface component 926 shows the relationships between perspectives through a branch such as branch 928. Further, perspectives may be grouped according to their frequency domain. For example, perspectives may be represented in outer ring 930 representing one frequency domain or in inner ring 932 representing a different frequency domain. Further, temporal visualization interface component 924 may be used to determine the way a perspectives relationships change over a given time period. Each component 934 of temporal visualization interface 924 may represent a different time.

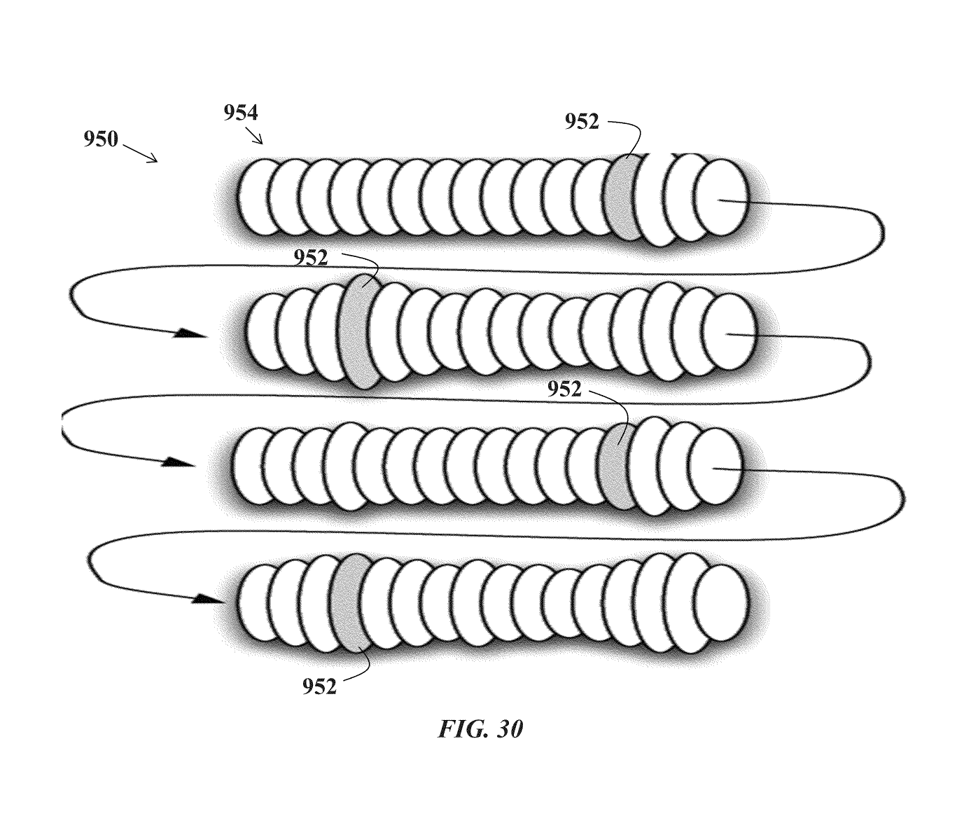

FIG. 30 shows another exemplary temporal visualization interface 950. In this example, a user specifies a cycle frequency of sixty-four (64) and further chooses to view four (4) time series chunks 954 of information. Thus, there are sixteen (16) samples in each chunk 954. Dark slices 952 represent a pattern which emerges due to the sampling frequency and folding of the timeline represented in FIG. 30. In this case, chunks 954 represent a hierarchical abstraction of the sixty-four (64) sample-frequency.

Other ways of relating temporal state relations may also be used. For example, the temporal visualization interface may also present a folded version of a timeline on three-axes. This representation imparts a greater understanding of the data represented. For example, a user may choose to create a 192 sample temporal visualization interface in three dimensions. In this case, each chunk may be eight samples long along the x-axis, followed by a folding of the timeline, similar to that shown in FIG. 30, to create an eight by eight (8×8) grid of samples in the x-y plane, creating sixty-four (64) samples. Followed by a similar folding in the z axis leading to an eight by eight by three (8×8×3) folded visualization of the timeline for 192 samples. Thus, patterns may be identified in three (3) frequencies (192, 24, and 3) instead of 2 (64 and 4).

In addition, PML comprises several other features that allow users to model systems more efficiently and with less cost. PML allows developers to not only define PML relationships in terms of the user interfaces described above, but also through other languages or programs such as XML, YAML, and Microsoft Excel. To do this, modeling classes are defined which includes the general relationship between objects without the instance of time. Methods may be used to parse, sort, and analyze the data contained in a text file or program into these modeling classes and store them in the object space. The method then infers the number of possible states, which is adjusted according to the evaluated completeness of the information. The method then associates the different perspectives with any related perspectives, giving a PML model.

FIG. 30 shows a further temporal visualization interface

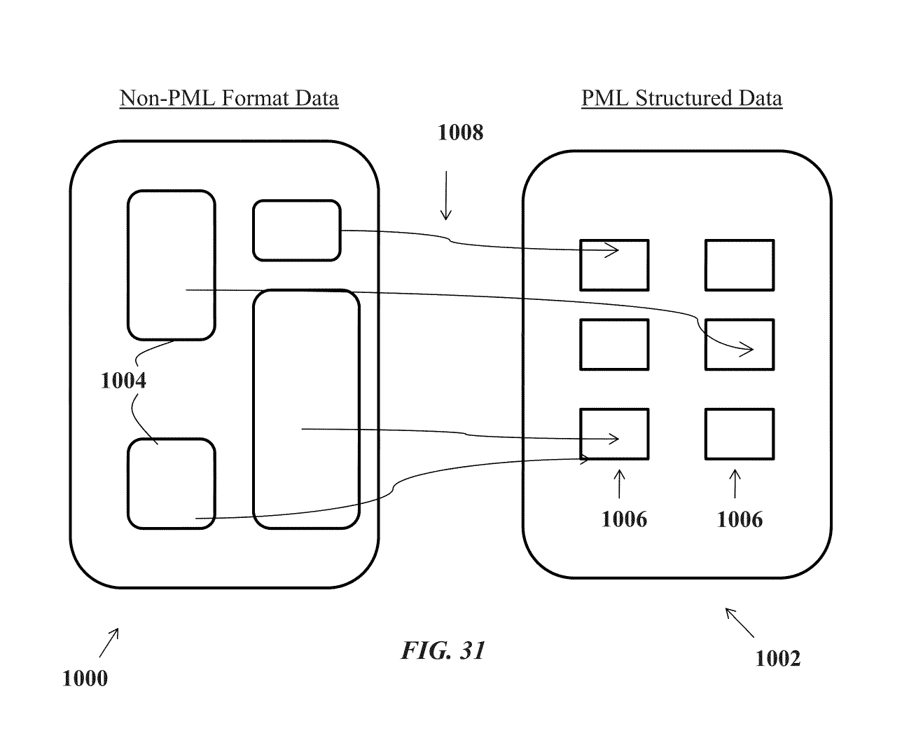

FIG. 31 illustrates the mapping of data from a non-PML language to PML. FIG. 31 shows an illustrative example of the PML Engine performing automatic semantic categorization 1008 to map fields 1004 of a non-PML data format 1000 (ex. Excel) to PML format 1002 fields 1006. The PML engine performs this function through knowledge of the PML ontology. Further, automatic semantic categorization uses machine learning techniques to map undefined data sources to a set of classes. The PML engine makes an inference as to which perspective class the data belongs to probabilistically. This is known as a class inference. Thus, automatic semantic categorization may be used to map data to existing PML relationships.

Perspective modeling is the process of gathering and applying information about a perspective/information/object “triple” to define the function and structure of the perspective, information exchanged between the perspective/object, and the object itself. With perspective modeling, objects get broken down to be modeled with regards to perspectives. Each interaction details the information (both word and information type) being transferred. It also details the “completeness” of each diagram relative to its structure. Information interactions may help define the related object structure and transmission medium.

Now that definitions of various aspects of a PML have been given, the reader is directed to an example scenario for implementing the teachings of the present disclosure. Note that the example below applies to only one of many fields wherein the present disclosure may be applied. The example below is intended to provide the reader a better understanding of the components of the present disclosure.

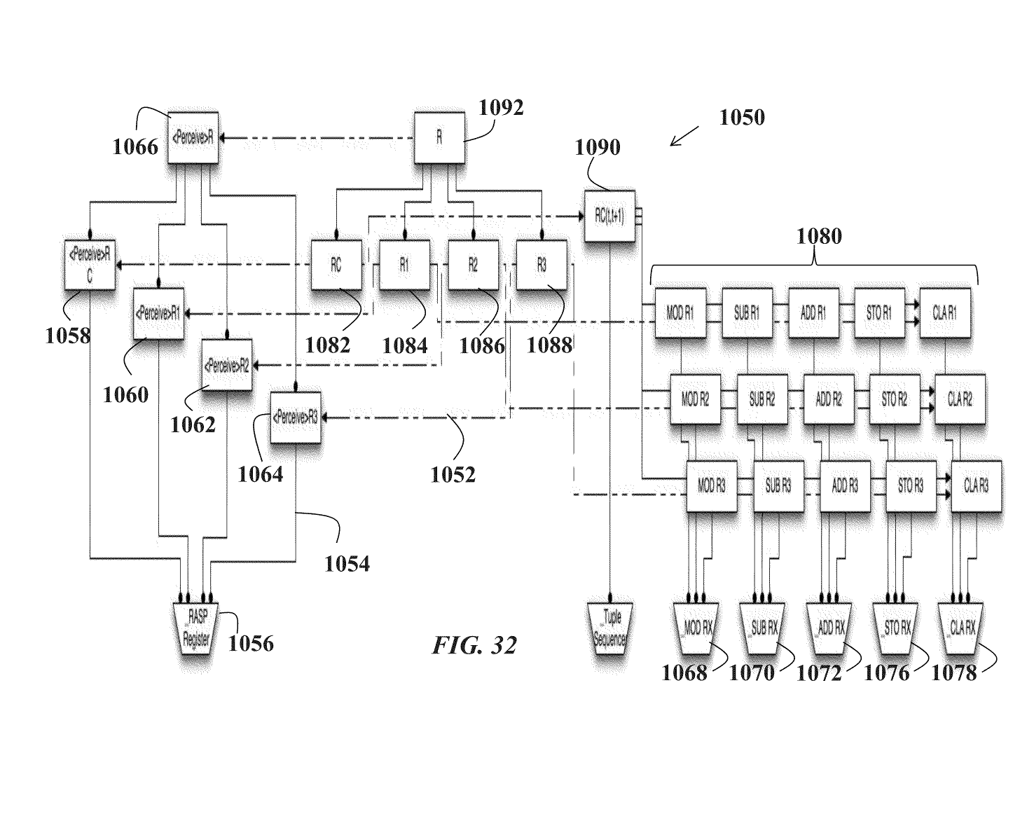

FIG. 32 shows PML ontology 1050 which may define a four-bit processor. More specifically, PML ontology 1050 implements a Random Access Stored Procedure (RASP) machine. The processor includes four (4) registers R1, R2, R3, and R4. Each register may store values in the range of negative (−7) to eight (8) inclusive. Further, the processor includes a total of fifteen instructions listed below.

### ADD R1: RC=RC+R1

### ADD R2: RC=RC+R2

### ADD R3: RC=RC+R3

### SUB R1: RC=RC−R1

### SUB R2: RC=RC−R2

### SUB R3: RC=RC−R3

### MOD R1: RC=RC % R1

### MOD R2: RC=RC % R2

### MOD R3: RC=RC % R3

### STO R1: R1=RC

### STO R2: R2=RC

### STO R3: R3=RC

### CLA R1: RC=R1

### CLA R2: RC=R2

### CLA R3: RC=R3

The tables below show how the PML Engine may create PML Ontology 1050.

TABLE 1
_RASP Register Implementation

| | State | | | | | | | | | | | | | | | |
|---|---|---|---|---|---|---|---|---|---|---|---|---|---|---|---|---|
| Input | −8 | −7 | −6 | −5 | −4 | −3 | −2 | −1 | 0 | 1 | 2 | 3 | 4 | 5 | 6 | 7 |
| −8 | −8 | null | null | null | null | null | null | null | null | null | null | null | null | null | null | null |
| −7 | null | −7 | null | null | null | null | null | null | null | null | null | null | null | null | null | null |
| −6 | null | null | −6 | null | null | null | null | null | null | null | null | null | null | null | null | null |
| −5 | null | null | null | −5 | null | null | null | null | null | null | null | null | null | null | null | null |
| −4 | null | null | null | null | −4 | null | null | null | null | null | null | null | null | null | null | null |
| −3 | null | null | null | null | null | −3 | null | null | null | null | null | null | null | null | null | null |
| −2 | null | null | null | null | null | null | −2 | null | null | null | null | null | null | null | null | null |
| −1 | null | null | null | null | null | null | null | −1 | null | null | null | null | null | null | null | null |
| 0 | null | null | null | null | null | null | null | null | 0 | null | null | null | null | null | null | null |
| 1 | null | null | null | null | null | null | null | null | null | 1 | null | null | null | null | null | null |
| 2 | null | null | null | null | null | null | null | null | null | null | 2 | null | null | null | null | null |
| 3 | null | null | null | null | null | null | null | null | null | null | null | 3 | null | null | null | null |
| 4 | null | null | null | null | null | null | null | null | null | null | null | null | 4 | null | null | null |
| 5 | null | null | null | null | null | null | null | null | null | null | null | null | null | 5 | null | null |
| 6 | null | null | null | null | null | null | null | null | null | null | null | null | null | null | 6 | null |
| 7 | null | null | null | null | null | null | null | null | null | null | null | null | null | null | null | 7 |

The PML engine may parse the information in the above table to create a state machine for a perspective. This information could be given in a spreadsheet program for example. States negative eight (−8) through seven (7) may be achieved based on the appropriate input to the perspective as shown in the table above. Further, the table shows the output of the perspective based on an input and a state. In this case, the PML engine implements the state machine in terms of functional model RASP Register 1056 as shown in FIG. 32.

As shown in FIG. 32, functional model RASP register 1056 hierarchically materializes perspectives <perceive>RC 1058, <perceive>R1 1060, <perceive>R2 1062, and <perceive>R3 1064. Since perspectives 1058, 1060, 1062, and 1064 terminate in functional model RASP register 1056, the perspectives' state changes will occur based on the functional model and their environmental relationships. Further, perspective <perceive>R 1066 hierarchically abstracts perspective 1058, 1060, 1062, and 1064. Thus, the state changes of perspective 1066 occur in relation to perspectives 1058, 1060, 1062, and 1064.

The table below shows a partial implementation of functional model 1068. Function model 1068 implements an ADD instruction for the _RASP machine.

TABLE 2
Partial _ADD RX implementation
_ADD RX

| RC | RX | RC+ | RC | RX | RC+ |
|---|---|---|---|---|---|
| −8 | 7 | −1 | 0 | 7 | 7 |
| −8 | 6 | −2 | 0 | 6 | 6 |
| −8 | 5 | −3 | 0 | 5 | 5 |
| −8 | 4 | −4 | 0 | 4 | 4 |
| −8 | 3 | −5 | 0 | 3 | 3 |
| −8 | 2 | −6 | 0 | 2 | 2 |
| −8 | 1 | −7 | 0 | 1 | 1 |
| −8 | 0 | −8 | 0 | 0 | 0 |
| −7 | 7 | 0 | 0 | −1 | −1 |
| −7 | 6 | −1 | 0 | −2 | −2 |
| −7 | 5 | −2 | 0 | −3 | −3 |
| −7 | 4 | −3 | 0 | −4 | −4 |
| −7 | 3 | −4 | 0 | −5 | −5 |
| −7 | 2 | −5 | 0 | −6 | −6 |
| −7 | 1 | −6 | 0 | −7 | −7 |
| −7 | 0 | −7 | 0 | −8 | −8 |
| −7 | −1 | −8 | 1 | 6 | 7 |

As shown above, the PML engine may use the information above to implement functional model _ADD RX 1068. One having ordinary skill in the art will note that other input states not shown will also be needed to implement the functional model. Further, one should note that certain states of RX may be purposely omitted. For example, state RC negative (−8) and states RX negative 1 (−1) through negative eight (−8) have been purposely omitted since RC may only include values in the range of negative eight (−8) to seven (7). Again, the above table only shows a partial implementation of functional model 1068.

Similar tables may be constructed to implement functional models 1070, 1072, 1076, and 1078. Functional models 1068, 1070, 1072, 1076, and 1078 hierarchically materialize perspectives 1080. Perspectives 1080 realize the instruction set described heretofore. Further perspectives 1080 have environment relationships with perspectives 1082, 1084, 1086, and 1088 in accordance with FIG. 32. Perspective 1090 has composite relationships with perspectives 1080 and an environment relationship with perspective 1082 in accordance with FIG. 32.

The same clock defines all perspectives in this particular example. Other examples may necessitate the use of different clocks for different perspectives.

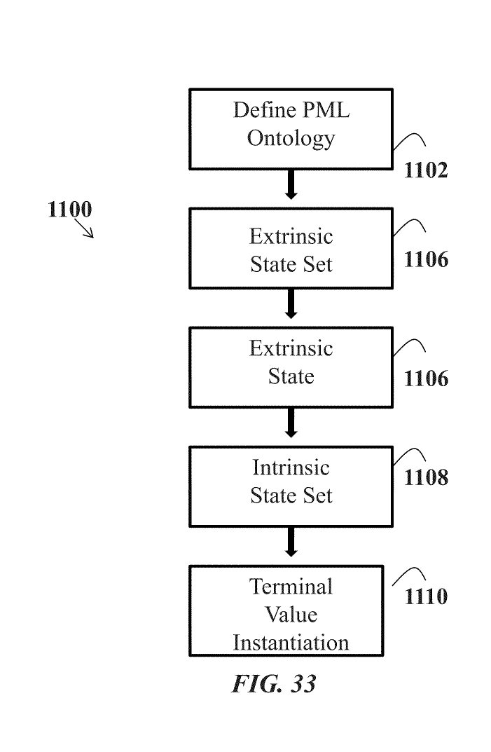

FIG. 33 shows flow diagram 1100 for forming a PML. First, in step 1102, the ontology must be defined as discussed in the example above. The PML engine defines the ontology in terms of a graph. The PML defines all perspectives as nodes and each relationship as an edge. Although a graph has been used in the present example, the PML engine may use other constructs to define the ontology onto a memory system.

Next, the PML engine defines the extrinsic state set in step 1104. The extrinsic state set represent all the possible states for each perspective based on the definitions described in the PML ontology. In this case, perspectives 1082, 1084, 1086, and 1088 may have values between −8 and 7 based on _RASP register functional model 1056. Further, perspectives 1080 will have states in accordance with their functional model definitions. The PML Engine may infer other states not specifically discussed, but still in accordance with the definition of the PML ontology.

In step 1106, the PML engine consolidates the extrinsic states to reduce the information entropy of the system. This consolidated state set is known as the intrinsic state set. The PML engine produces the intrinsic state set by reducing redundant states for each perspective. In the above four-bit processor example, the PML Engine does not produce an intrinsic state set since no values of perspectives are repeated. However, suppose one perspective hierarchically materializes two different perspectives. In this case, the intrinsic state set would be reduced since both materialized perspectives share the same set of states with the composite perspective. The extrinsic state set can be reduced through methods such as Huffman coding, arithmetic coding, or other information entropy reducing methods.

In step 1108, the user instantiates the perspectives for a given time range. Suppose the user instantiates perspectives 1082, 1084, 1086, and 1088 with [RC(*), R1(*), R2(*), R3(*)], <Perceive>R(*)]. In this case, all values for all perspectives are instantiated for all times since no data is input to limit the instantiation. Now suppose the user inputs <Perceive>RC(7): 1, <Perceive>R1(7): 2, <Perceive>R2(7): −5, and <Perceive>R3(7): 1.

The steps of flowchart 1100 may be used to produce useful queries, simulations, and information from the system being modeled. For example, one could derive the possible state sets at t=6, t=5, t=4, etc. that the four-bit processor was in prior to t=7. A user may perform other useful queries, simulations, and information gathering. For example, if one knew the state at t=4 and t=7 for some given perspectives a useful state set for times t=5 and t=6 could be derived.

This is only one example for further explaining the features of the present disclosure. Other applications of the present disclosure may be known to those having ordinary skill in the art. Further, other input methods may be used to generate the PML Ontology. For example, the data could be input through Interaction, Communication, and Perspective diagrams as mentioned heretofore.

As seen above, the processing features and functions described herein may be implemented in various manners. For example, the present embodiments may be implemented in an application specific integrated circuit (ASIC), a microcontroller, a digital signal processor, or other electronic circuits designed to perform the functions described herein. Moreover, the process and features here described may be stored in magnetic, optical, or other recording media for reading and execution by such various signal and instruction processing systems. Another embodiment may be the use of the PML over a webpage, wherein the modeling is done using a virtual machine that utilizes PHP and API to provide a web-based modeling program, in which the object space for perspectives are stored on a central server. The foregoing description of the preferred embodiments, therefore, is provided to enable any person skilled in the art to make or use the claimed subject matter. Various modifications to these embodiments will be readily apparent to those skilled in the art, and the generic principles defined herein may be applied to other embodiments without the use of the innovative faculty. Thus, the claimed subject matter is not intended to be limited to the embodiments shown herein but is to be accorded the widest scope consistent with the principles and novel features disclosed herein.

What is claimed is:

1. A method for modeling a system, comprising the steps of:
forming a plurality of perspectives comprising a plurality of states, said plurality of perspectives representing a localized frame of reference;
associating said plurality of states through at least one temporal state transition, said at least one state transition compatible with said localized frame of reference;
associating said plurality of perspectives through at least one semantic communication relationship;
encoding said plurality of perspectives in a computer readable storage medium;
forming an information modeling language by creating at least one function associating said plurality of perspectives for modeling at least one observable system;

2. The method of claim 1, wherein the step of associating said plurality of perspectives through at least one semantic communication relationship, said at least one semantic communication relationship further comprising any one of a compositional relationship, environmental relationship, or object relationship.

3. The method of claim 2, further comprising the step of creating a perspective interaction model for associating said plurality of perspectives through said object relationship.

4. The method of claim 1, wherein the step of encoding further comprises the step of encoding any one of an interaction graph, a network graph, or composition graph.

5. The method of claim 4, further comprising the step of creating a context for said perspectives by taking the union of said interaction graph, said network graph, and said composition graph.

6. The method of claim 5, further comprising the step of creating a perception function for at least one of said plurality of perspectives.

7. The method of claim 1, further comprising the step of creating a number of inferred instances of said states and said state transitions for said plurality of perspectives.

8. The method of claim 1, further comprising the step of creating a query;

9. The method of claim 1, further comprising the step of creating an extrinsic state set of said plurality of perspectives.

10. The method of claim 1, further comprising the step of instantiating an intrinsic state set of said plurality of perspectives.

11. The method of claim 1, further comprising the step of creating a simulation for said information modeling language.

12. The method of claim 1, further comprising the step of generating a value for information entropy in the model.

13. A computer readable storage medium encoded with a program for modeling a system, said computer readable storage medium comprising:
a user-interface for creating an ontology;
said ontology defining a model, said ontology comprising:
a plurality of perspectives comprising a plurality of states, said plurality of perspectives representing a localized frame of reference;
said states associated through at least one temporal state transition, said at least one state transition compatible with said localized frame of reference; and
said perspectives associated through a predetermined number of semantic communication relationships;

14. The computer readable storage medium of claim 13, further comprising an automatic categorization schema for defining said ontology.

15. The computer readable storage medium of claim 13, further comprising a means for storing an existing ontology.

16. The computer readable storage medium of claim 13 further comprising a means for sharing an existing ontology.

17. The computer readable storage medium of claim 13, further comprising a temporal visualization interface.

18. The computer readable storage medium of claim 13, wherein said semantic communication relationships comprise any one of a composition relationship, an environment relationship, or an object relationship.

19. The computer readable storage medium of claim 13, wherein said computer readable storage medium comprises a means for determining an information entropy value of said model.

20. A Perspective modeling language (PML) encoded on computer readable storage medium for modeling at least one system according to a localized frame of reference for an object, said computer readable storage medium comprising:
a user-interface for defining an ontology onto a computer readable storage medium;
said ontology for modeling at least one observable system, said ontology comprising:
a plurality of perspectives comprising a plurality of states, said plurality of perspectives representing a localized frame of reference;
said states associated through at least one temporal state transition, said at least one state transition compatible with said localized frame of reference; and
said perspectives associated through a predetermined number of semantic communication relationships;
a PML engine for inferring an extrinsic state set of said plurality of perspectives;
said PML engine for instantiating an intrinsic state set of said plurality of perspectives;
